(19) United States
(12) Patent Application Publication
(10) Pub. No.: US 2003/0228895 A1
(43) Pub. Date: Dec. 11, 2003

(54) Turn-based strategy game

(76) Inventor: Noel M Edelson, New Rochelle, NY (US)

Correspondence Address: David L Schaeffer, Stroock & Stroock & Lavan, 180 Maiden Lane, New York, NY, 10038, US

(21) Appl. No.: 10/398,074

(22) PCT Filed: Oct. 5, 2001
(86) PCT No.: PCT/US01/31638

(51) Int. Cl. A63F 13/00

(52) U.S. Cl. 463/1

(57) ABSTRACT

A collection of turn-based, multiple-player strategy games is based on a common logical problem, in which “Best Strategist” players seek to maximize their point scores by “Taking” or “Passing” rings of a uniform, nominal value from a fixed, known supply which, when exhausted, makes available a ring of greater value to the player having the next turn. Games are grouped into three skill levels, each containing several sub-games generated by varying particular rules; rules are modular in that elements of different games can be combined to create new, hybrid games with a well-defined structure. There are two preferred embodiments of The Ring Game, a physical version and an electronic version, the latter playable on various platforms including, but not limited to, game player/TV monitors; hand-held wireless devices; and computers.

### CROSS-REFERENCE TO RELATED APPLICATION

This application claims priority of U.S. Provisional Application No. 60/133,729, filed May 12, 1999, and U.S. Provisional Application No. 60/260,161, Jan. 5, 2001, the contents of both of which are incorporated herein by reference.

### FIELD OF THE INVENTION

The present invention is directed generally to turn-based, multiple-player strategy games.

### SUMMARY OF THE INVENTION

This invention is a collection of tum-based, multiple-player strategy games based on a common logical problem, in which “Best Strategist” players seek to maximize their point scores by “Taking” or “Passing” rings of a uniform, nominal value from a fixed, known supply which, when exhausted, makes available a ring of greater value to the player having the next turn. The games are grouped into three skill levels, each containing several sub-games generated by varying particular rules; rules are modular in that elements of different games can be combined to create new, hybrid games with a well-defined structure. There are two preferred embodiments of The Ring Game, a physical version and an electronic version, the latter playable on various platforms including, but not limited to, game player/TV monitors; hand-held wireless devices; and computers. Canonical games are meticulously described in the section titled “Attachments: Table-Top Version of The Ring Game”.

More specifically, this invention is a turn-based strategy game which by way of example can have three skill levels, and which can be played on both table-top and electronic platforms. Various terms used herein are defined in the glossary section of this application.

Game setting is a carousel, alongside of which is a ring dispenser containing a known number of silver rings followed by a single gold ring. Parameters include: the point value for a silver ring (always one) and for the single gold ring (always greater than one); the maximum number of rotations, and the playing position having the last turn on the final rotation. The elementary (Apprentice-Level) Ring Game is entirely deterministic; the goal is to maximize one's point score. Intermediate (Squire-Level) and advanced (Chevalier-Level) versions of The Ring Game incorporate randomness and uncertainty; there, the objective is to maximize Expected Point Score. There are to be two representations of the table-top Ring Game, one popularly-priced, the other an upscale, elegant model. Electronic platforms for The Ring Game include: game player/television monitor systems; hand-held wireless devices; personal computers. A unique feature is The Ring Game Web site, which, in addition to online play, offers chat rooms, quizzes, playing hints, links to related materials and player submissions. All electronic versions support the Tournament Scribe, a software program that produces a “performance rating” for real players at the end of each game.

In its preferred embodiment, the present invention

The present invention will be readily appreciated by those skilled in the art, such a trained game theorists, in view of the accompanying drawings and following detailed description.

### BRIEF DESCRIPTION OF THE DRAWINGS

FIG. 1 depicts an 8-position carousel with an octagonal panel displaying numbered playing positions and Strategy/Identity cards, a Ring Pole being shown behind each horse.

FIG. 2 shows an 8-position carousel with an octagonal panel displaying numbered playing positions and Strategy/Identity cards and a separate ring dispenser comprising holders for silver rings remaining cards and rotations remaining cards and a spindle for displaying an ordered sequence of rings;

FIG. 3 is a close-up view of a Ring Pole and Strategy/Identity cards;

FIG. 4 is a close-up of a player placing a silver ring on her horse's Ring Pole;

FIG. 5 is a close-up of a carousel horse;

FIG. 6 is a close-up of a ring dispenser with silver rings remaining and rotations remaining cards and an ordered sequence of rings on the spindle;

FIG. 7 is a Game Card for a 5-player canonical Apprentice-Level Game, displaying 10 sets of parameter values, with the character in the last playing position having the final move on the last rotation, if the game reaches that point. If they wish, players can use silver rings remaining cards to randomly assign final-mover status, as described in the “Attachments . . . ”;

FIG. 8A is a Game Card for a two-player, canonical Squire-Level Game 2 (uncertain end point), displaying 10 sets of parameter values and 10 corresponding sets of conditional probabilities for an extra turn, as shown in FIG. 8B, the random event being resolved by appropriate combinations of blank and Extra Turn Random Event cards;

FIGS. 9A and 9B are the same as FIGS. 8A and 8B, but with the “envy” penalty;

FIG. 10 is the Table which covers the canonical Squire-Level Games 1 and 3 and the canonical Chevalier-Level Games 1 and 2, the combinations of blank and Extra Turn Random Event cards being used to resolve random events arising from the Rule Refinement and “clumsy” Always Takers; the combinations of Best Strategist and Always Taker cards being used to make random assignment of strategy types to players;

FIGS. 11A and 11B are the Game Card for 5- and 6-player canonical Chevalier-Level Game 1a, which features a random assignment of known numbers of strategy types to players, a player's strategy type being concealed from other players;

FIGS. 12A and 12B are the Game Card for 3- and 4-player canonical Chevalier-Level Game 1b, which features a binomial assignment of strategy types to players, a player's assigned strategy type being concealed from other players;

FIGS. 13A and 13B are the Game Card for canonical Chevalier-Level Games 2a and 2b, the location choice game for a p-c with predetermined numbers of strategy types and binomial distribution of strategy types, respectively, assigned strategy types being unknown to other players;

FIGS. 14A and 14B are the Game Card for the 6-player canonical Chevalier-Level Games 3 and 4, featuring Position Exchange and Bumping Process, respectively. Strategy types are randomly assigned, but known to other players;

FIG. 15 depicts an opening screen for an electronic version of the Ring Game, and this screen can be animated and accompanied by music and voice-overs.

FIG. 16 shows the second (Welcome) screen, and has buttons for a navigation menu;

FIG. 17 depicts the third (About) screen; the scroll bar can be enabled to continue text display;

FIG. 18 shows the fourth (Background) screen, the scroll bar being enabled to continue text display;

FIG. 19 depicts a “link” from the highlighted word carousels in the text from the Background screen;

FIG. 20 illustrates the fifth (Essentials) screen; the scroll bar being enabled to continue text display;

FIG. 21 shows a screen which allows a viewer to review the play of a particular game, to practice playing against the computer in an already set-up two-person Apprentice-Level game, and for experienced players to configure their own Apprentice-Level game;

FIG. 22 portrays a screen for step 1 of Set-Up, creating numbers and strategy types of characters;

FIG. 23 illustrates a screen which allows a player to use one of three Apprentice-Level Game cards or to direct the Tournament Scribe to randomly create a parameter set. This is the second step of Set-Up, and presupposes that the numbers and strategy types of characters have already been selected;

FIG. 24 depicts a screen showing one move of the scripted game;

FIG. 25 portrays a screen showing the scores and performance ratings from one game;

FIGS. 26A-C are flow charts showing how the table-top version of the ring game can be played; and

FIGS. 27A-C are flow charts showing how the table-top version of the ring game can be played.

### DESCRIPTION OF THE PREFERRED EMBODIMENT

The present invention relates to a turn-based strategic game known as the Ring Game. This game can be played as a table-top version, a computer based version, and an Internet-based version allowing players remote from one another to participate via the World Wide Web.

Table-Top Version of The Ring Game

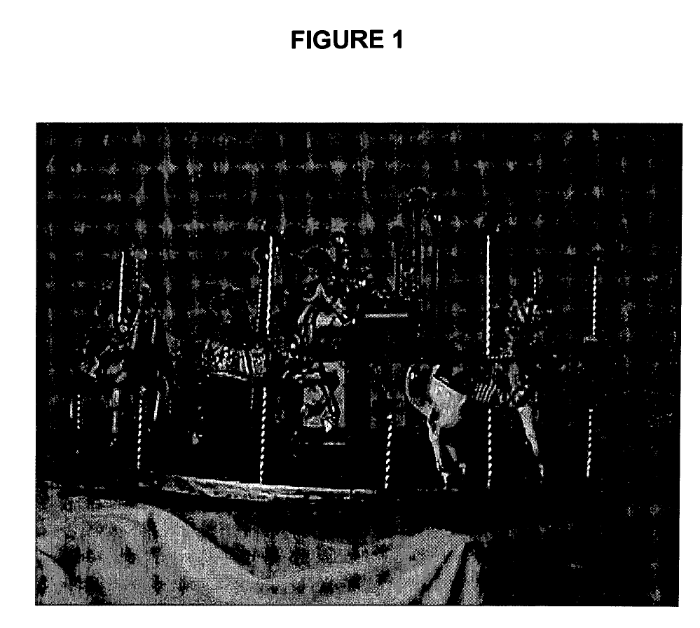

The table-top version of the ring game can be better understood with reference to the accompanying FIGS. 1-6 and 26A-C, showing the structure and various steps involved with setting up and playing the game. Those steps will now be described.

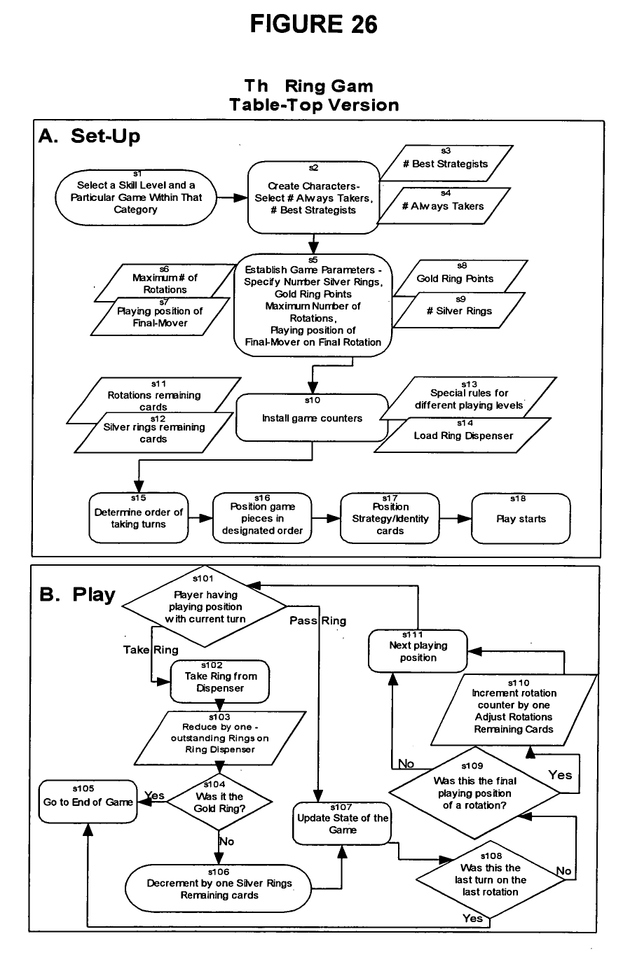

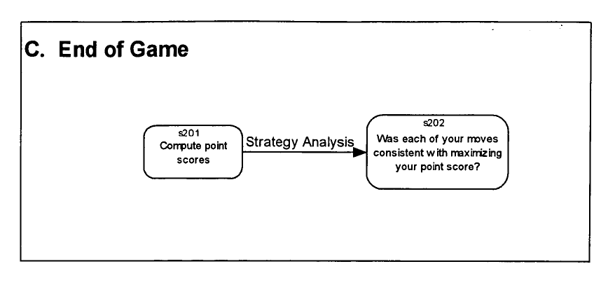

Turning to FIGS. 26A-C, in step S1 the real players select an appropriate skill level from three choices: elementary (Apprentice-Level); intermediate (Squire-Level); and advanced (Chevalier-Level). From within the selected skill level, Real Players choose a particular game.

One can play a canonical Apprentice-Level Game (deterministic). In a variation, rather than fixing a particular value for the most valuable ring, the value may be an agreed-upon proportionality factor times the number of less valuable rings taken by the player who secures the more valuable ring.

As a further refinement, one can play a canonical Squire-Level Games (randomness, but known probabilities). These games can be varied using rule refinement, uncertain end point and/or “Clumsy” Always Takers.

Canonical Chevalier-Level Games can have uncertain identities and repositioning. As variations, games can be concealed strategy types, location choice with concealed strategy types, position exchange and repositioning via a bumping process.

Steps S2-S4, correspond to the set-up in step S1, and relate to the creation of characters.

S5-S9 correspond to Step S2 of the set-up. Game parameters are established. For Squire-Level and Chevalier-Level Games, the parameters can include the probabilities for random events.

In steps S10-S14 the silver rings remaining and rotations remaining cards are prepared and put in holders of the ring dispenser, and an agreed-upon number of rings are installed into the ring dispenser. Note examples of special conditions, e.g., a formulaic value for the valuable ring or an “envy” factor.

In step S15 silver rings remaining cards are used to randomly assign characters to numbered playing positions.

In step S16 characters' horses are placed about the turntable at their assigned playing positions, and the turntable is rotated so that the horse in playing position #1 opposes the ring dispenser.

Then, in step S17 characters' strategy/identity cards are inserted into the panel opposite their horses. These can be exposed, except in Chevalier-Level games 1a,1b,2a,2b, when their blank sides show.

In step S18 the character in playing position #1 makes the first move of the game.

The turntable is rotated in step S101 so the player whose turn it is has their horse opposite the ring dispenser. The player then moves.

In step S102 the player's move is to take the available ring from the ring dispenser.

In step S103 the exposed silver rings remaining card is removed.

Proceeding to steps S104 and S105, if the ring removed from the ring dispenser is the gold ring, the game is over. Otherwise, as in steps S104 and S106, the next exposed card indicates the state of the ring dispenser for the player having the next turn.

In step S107, it is determined whether the next player has a turn at the ring dispenser.

Moving to steps S108-S111, if there are no additional turns, the game is over. Otherwise, a determination is made whether the player having the next turn does so on the same rotation number. If so, the rotations remaining card stays in the holder. The turntable is rotated so that the horse in the playing position with the next highest integer is located opposite the ring dispenser, and play continues. Otherwise, the exposed rotations remaining card is removed, exposing the card displaying the next smallest integer. The turntable is rotated so that the horse in playing position #1 is opposite to the ring dispenser, and play again continues.

Players compute their point scores in step S201 by adding up the silver rings on their ring poles. If a player has taken the gold ring, that player adds that ring's point value to their silver ring total.

In step S202 real players reprise the sequence of takes and passes which lead to the particular game outcome. Either individually or collectively, they try to determine whether their moves were consistent with the objective of obtaining the highest possible point score.

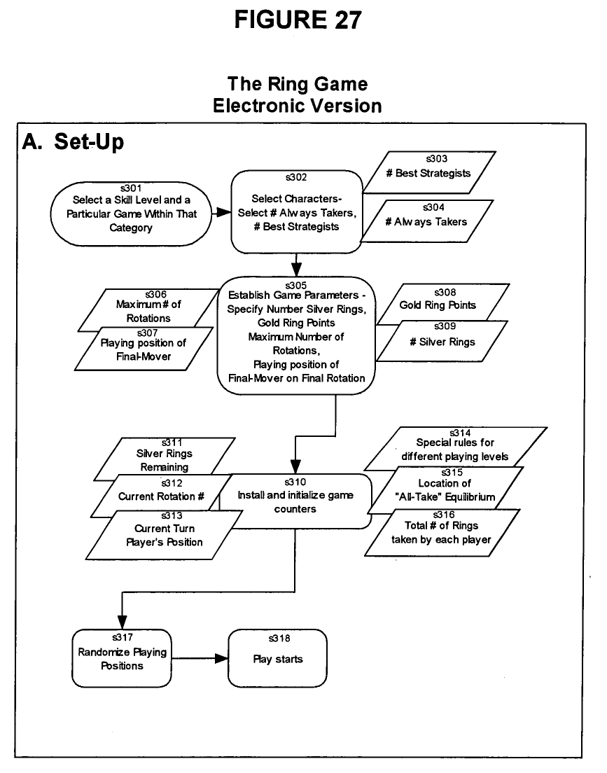

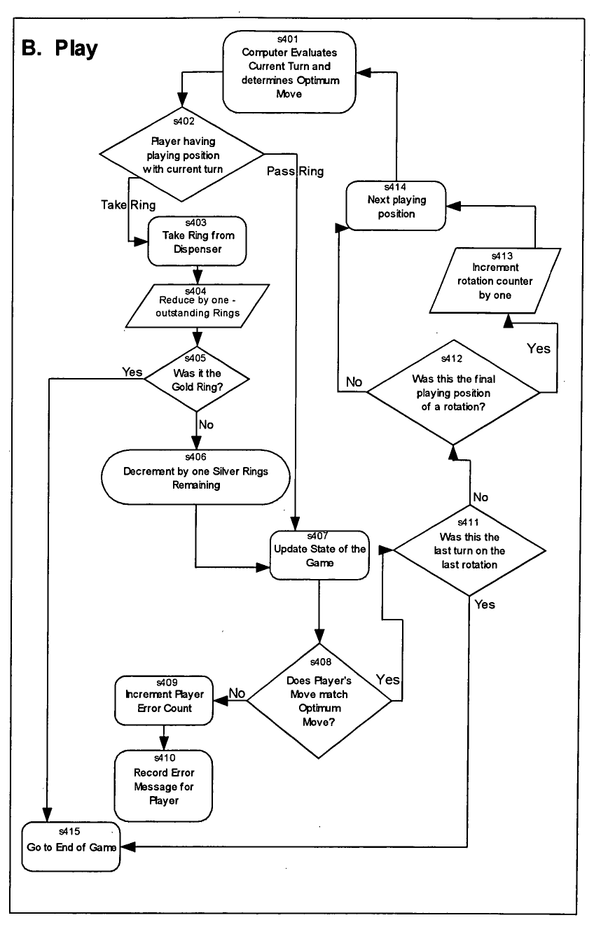

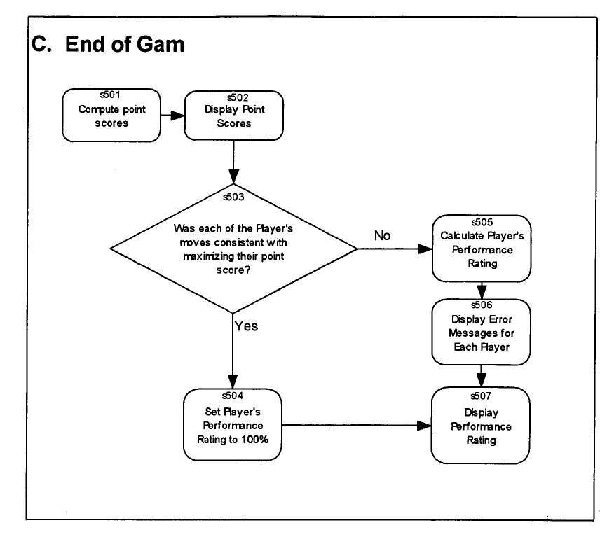

Next, FIGS. 27A-C, is a flow chart showing how an electronic version of the ring game can be implemented.

In step S301 software prompts real players to select an appropriate skill level from three choices: elementary (Apprentice-Level); intermediate (Squire-Level); and advanced (Chevalier-Level). From within the selected skill level, real players choose a particular game. Examples of such games include canonical Apprentice-Level games (deterministic). As variations, rather than fixing a particular value for the most valuable ring, the value may be an agreed-upon proportionality factor times the number of less valuable rings taken by the player who secures the more valuable ring. Canonical Squire-Level Games (randomness, but known probabilities) can be varied with rule refinement, uncertain end points and “clumsy” Always Takers. At the Canonical Chevalier-Level of Games (uncertain identities and repositioning), variations can involve concealed strategy types, location choice with concealed strategy types; position exchange and repositioning via a bumping process.

Turning now to FIG. 27A, in steps S302-S304 software prompts real players through Step 1 of Set-Up. Characters are created via drag and drop.

In steps S305-S309 software prompts real players through Step 2 of Set-Up, and game parameters are established. The selected number of silver rings initializes that counter.

As shown at steps S310-S316, the initial playing position is #1, the initial rotation is #1, the initial number of rings taken by each player is zero and the location of the initial “all-take” equilibrium is determined by the initial number of silver rings.

Advancing to step S401, given the current state of the game (silver rings remaining, playing position at the ring dispenser, value of the gold ring, maximum number of rotations, playing position with the final move on the last rotation, probabilities of random events, if any), software determines whether, for a Best Strategist, a take or a pass is consistent with obtaining the highest possible (expected) point score. There is no such calculation for an Always Taker.

In steps S402/S403 the player whose turn it is takes the available ring.

In steps S402/S407 the player whose turn it is passes the available ring.

Software decrements by one the number of outstanding rings in step S404.

In step S405, if the ring removed was the gold ring, the game is over, otherwise, in step S406, software decrements the number of silver rings remaining by one.

Software updates the state of the game (silver rings remaining, playing position with the next move, current rotation number) in step S407.

In step S408, for real players, the software compares a Best Strategist's move with the optimal one.

In step S409 if the real player's move was incorrect, the software increments that player's error total by one. Otherwise, no error is recorded.

Software stores an appropriate error message in step S410, which depends on the state of the game when the real Best Strategist erred.

In steps S411-S414, if there are no additional turns, the game is over. Otherwise, a determination is made whether the player having the next turn does so on the same rotation number. If so, the existing rotation number is left unchanged and the next playing position is advanced to the ring dispenser, and play continues. Otherwise, the rotation number is incremented by one and the next playing position (#1) is advanced to the ring dispenser, and play continues.

In step S501, the number in the counter for silver rings taken by each player is obtained. If a player has taken the gold ring (that counter is non-empty), then its point total is added to the counter for the number of silver rings taken.

Game point scores for all plays are displayed in step S502, with Always Takers included.

The number in the error counter is obtained for each Real Best Strategist

In step S504, if the number in the error counter is zero, the Player's Performance Rating is 100. Otherwise, the real Best Strategist's Performance Rating is computed in step S505, according to the number of (unforced) correct moves (total number of unforced moves less the number of errors) divided by the total number of unforced moves, multiplied by 100.

The stored error messages are displayed in step S506, without indicating the moves on which these occurred.

Performance Rates less than 100 are displayed in step S507.

With the foregoing manner of operation in mind, various other aspects of this invention will now be described.

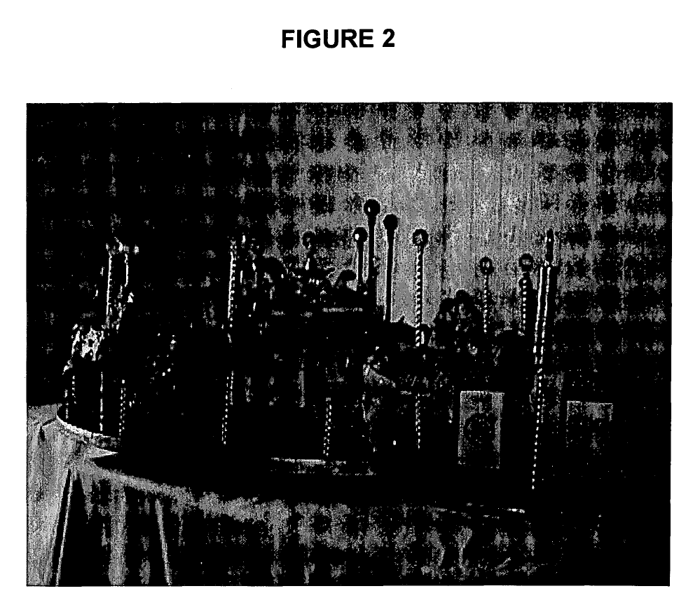

FIGS. 1 and 2 depict an 8-position carousel. Table-top versions of The Ring Game, both popularly-priced and upscale, can be 6-position carousels. The size and proportion of commercial carousels can be smaller than as shown, the reduction being determined by aesthetic and economic considerations irrelevant to the functionality of the invention. Table-top versions of The Ring Game can incorporate all critical components depicted in the photographs: numbered playing positions; Strategy/Identity cards; ring dispenser; silver rings and a single gold ring; silver rings remaining and rotations remaining cards.

Alternatively, and by way of non-limiting example, a six position carousel base with an hexagonal center panel and six openings about the circumference can be used. Carousel game pieces in the form of a horse with an attached Ring Pole as in the previous embodiment would be employed. By way of non-limiting example, the base can be 16″ in diameter, the hexagonal center panel 3.5″ w, 5″ h, and the horse base 5.75″ in diameter.

An alternative six-position carousel base with an hexagonal center panel and six opening about the circumference could be constructed such that the stand with the carousel horse and ring pole is 20″ in diameter, the hexagonal center panel 4″ w by 5.5″ h, and the horse base 7

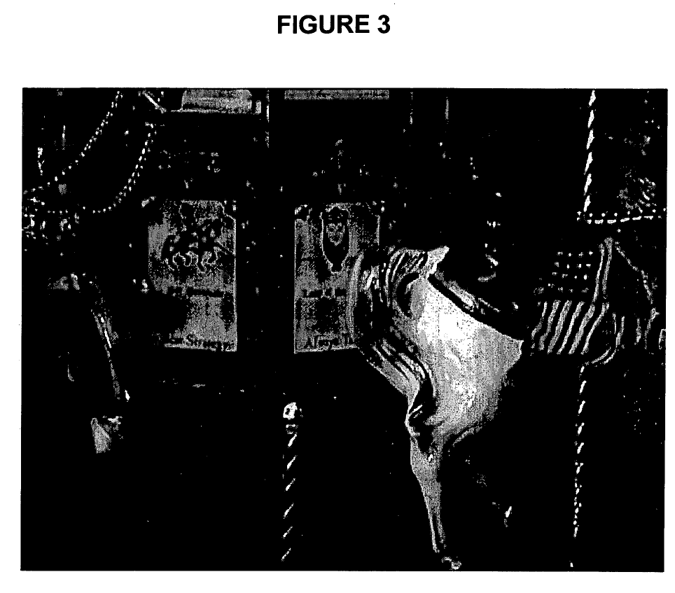

FIG. 3 is a further view of the decorative hexagonal center panel having strategy/identity card holders. Hinges allow the center panel to be folded into a box. Numbered playing positions are shown.

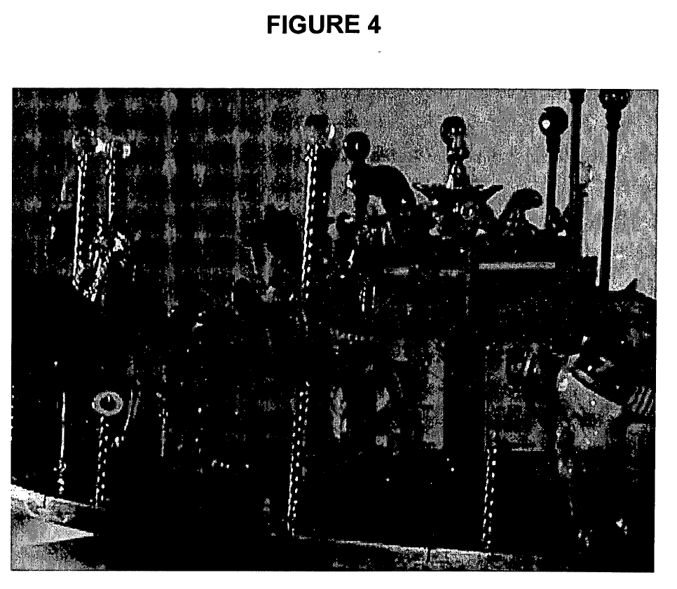

FIG. 4 depicts a decorative hexagonal center panel with strategy/identity card holders, and a player placing a silver ring on their horse's ring pole. Again, hinges allow the center panel to be folded into box, and there are numbered playing positions.

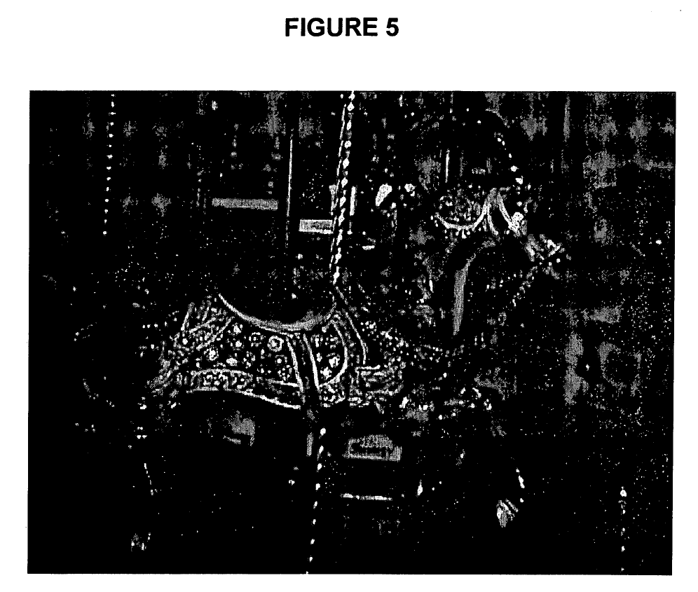

FIG. 5 shows a close-up of a carousel horse and a ring dispenser.

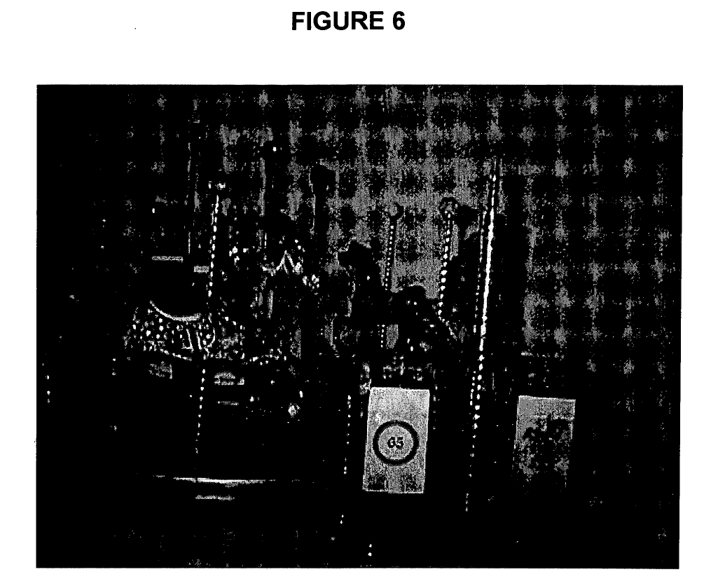

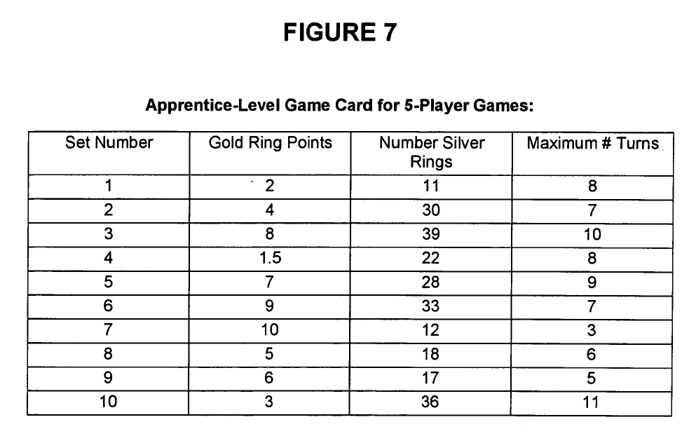

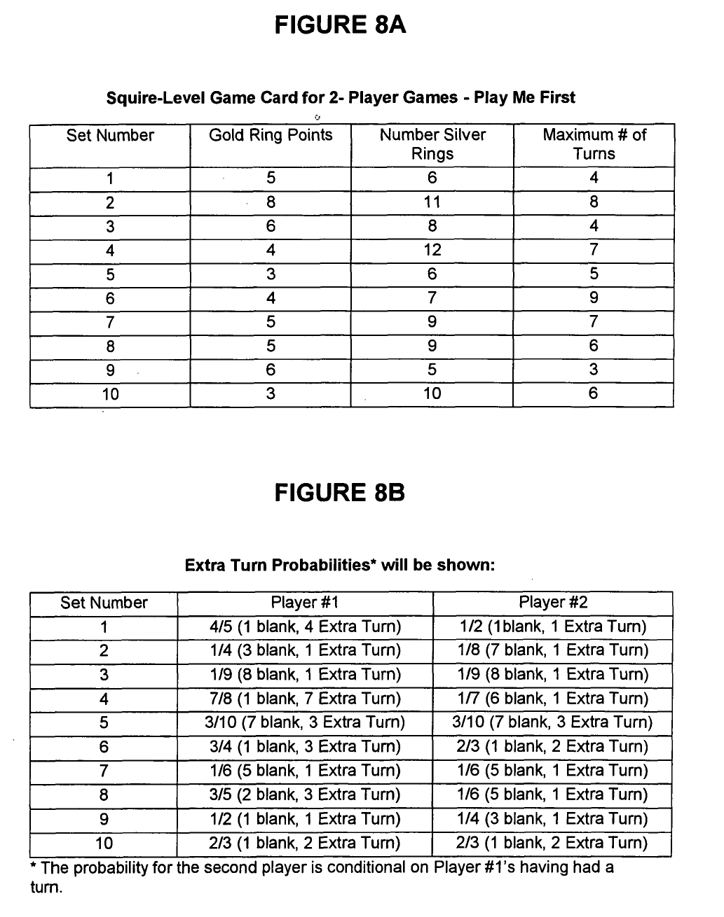

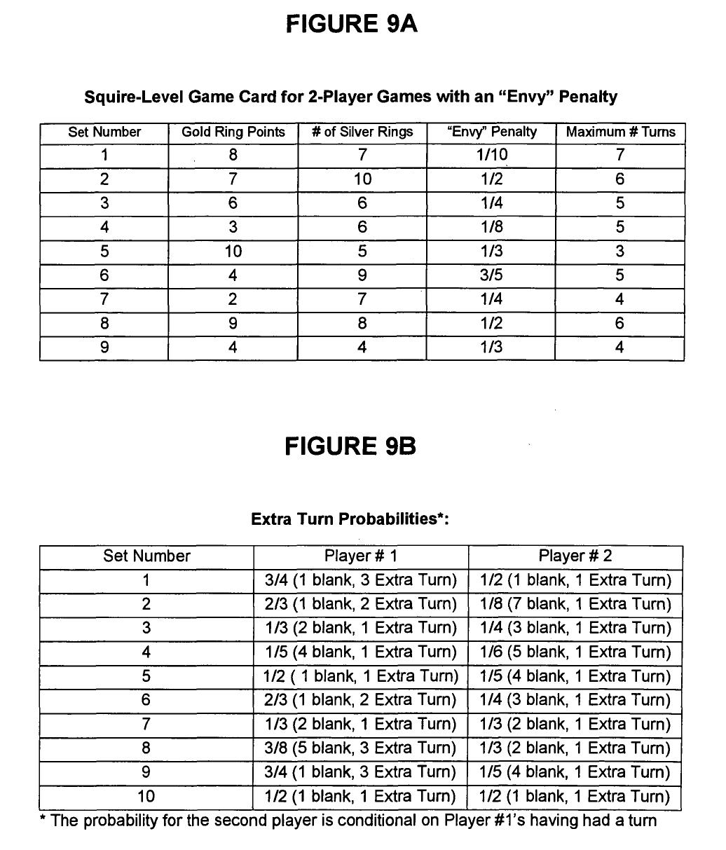

FIG. 6 is a close-up of a ring dispenser with holders for silver rings remaining and rotations remaining cards.

The table top version of this ring game can be played as follows.

For apprentice-level play, the game is first set up by assembling the six-position carousel by inserting the hinged, decorative, hexagonal center panel into the carousel base. The ring dispenser is placed on a surface just beyond the carousel base, opposite to the playing position #1. The carousel rotates in a counter-clockwise direction, which determines the horses' “forward” orientation and the order of taking turns.

The table-top version of this game is intended for at least two real players. Real players can agree to create a number of artificial characters which at every turn take the available ring; these automata acquire strategy/identity cards with the picture of a Jester and the designation “Always Taker”. The number of such artificial players cannot exceed the number of available positions after accommodating all real players.

Also, a real player could be a computer-generated player.

Once having decided the number of playing positions both real and artificial, real players choose three additional parameters: (1) the number of silver rings ahead of the single gold ring; (2) the number of points awarded for securing the gold ring; and (3) the final rotation, which defines the maximum number of (complete) rotations; this upper bound setting a limit to the duration of the carousel ride. There are Apprentice-Level game cards for carousels with 2-6 positions; these list interesting sets of values for the above three parameters, but players are free to choose their own.

The gold ring is placed on the ring dispenser, and above it the agreed-upon number of silver rings. This ensures that the gold ring is not exposed until all silver rings have been removed.

Next, real players select their Strategy/Identity cards from the set of male and female names; these carry the designation Best Strategist. Each Artificial Player is assigned a Strategy/Identity card with a Jester and the designation “Always Taker”. The Strategy/Identity cards are placed face-upward on a flat surface. Consecutively numbered silver rings remaining cards are taken, starting with “1”, equal to the number of playing positions. The silver rings remaining cards are shuffled and dealt one on top of each Strategy/Identity Card. This procedure randomly assigns the order of taking turns. Each Strategy/Identity card is placed into its appropriately numbered slot in the center panel.

Next, consecutively numbered silver ring remaining cards are removed starting with the number “one” equal to the agreed-upon number of silver rings. The same is done for the rotations remaining cards, with the largest value equal to the maximum number of rotations. Two “decks” are formed from these cards, each organized in reverse order, and they are inserted into separate holders on the ring dispenser.

At the outset of the game, one visible card displays the initial number of silver rings and the other the maximum number of rotations. The exposed card in each holder (“deck”) changes in a natural fashion as the game progresses, in order to remind players of the number of silver rings remaining ahead of the gold and the number of remaining rotations.

This completes set-up for the Apprentice-Level Ring Game. Accordingly, the carousel can have an assortment of Best Strategists and Always Takers in various playing positions. It is no simple task to figure out one's best strategy, because this depends on what other Best Strategists are expected to do.

Before starting play, participants can take time to devise a plan of action, but should be prepared to modify that strategy it in light of others' moves. In this regard, it should be understood that Real Players are Best Strategists who are allowed to Take or Pass the exposed ring, and Artificial Players are necessarily Always Takers.

For the mathematically inclined, it may be useful to consider what would be the game outcome if all Best Strategists played as well as possible? This abstraction can be solved using basic arithmetic.

Players will have fun and gain insights by playing against multiple Best Strategists with some Always Takers. But, for a systematic approach to learning, it may be preferable to begin by playing The Ring Game head-to-head against a single Best Strategist.

II. Play

After the first position player Takes or Passes the topmost silver ring, adjust the silver rings remaining cards in the ring dispenser. If the first move is a Take, remove the exposed silver rings remaining card; the next one displays the next smallest integer, corresponding to the reduced number of silver rings atop the gold ring. Conversely, if the first move is a Pass, leave unchanged the deck of silver rings remaining cards. In either case, remove the first rotations remaining card, which is equal to the maximum number of rotations, and place it face up in front of the ring dispenser; the number on the tabled card can be used to compute the rotation number in progress. This is accomplished by subtracting the number on the tabled rotations remaining card from the maximum number of rotations plus one. The rotations remaining card exposed in the ring dispenser holder shows the maximum number of complete rotations after the current one is completed. A player taking a silver ring places it on their ring pole; real players must accomplish this action for Always Takers. Then, rotate the carousel so that the horse in playing position #2 is opposite the ring dispenser.

After the last player has had their turn on the first rotation, the player in position #1 has their turn on the second rotation. Rotate the carousel so the horse in position #1 is opposite the ring dispenser. After that player has moved, table the exposed Rotations remaining card on top of the previous one. If the move is a Take, remove a silver rings remaining card; otherwise, leave unchanged the deck of silver rings remaining cards.

The game continues until a player secures the gold ring, or until the maximum number of Rotations is completed (each player has had the maximum number of turns). It can happen that someone secures the gold ring when the “Zero Rotations remaining” card is tabled. In that instance, the game has ended during the carousel's final Rotation.

III. Computing Point Scores

Since each silver ring is worth one point, players count the number of silver rings on their Ring Poles. If someone has secured the gold ring, add its point value to that player's silver ring total. It is possible that no one has secured the gold ring. This happens when all players have had their maximum number of turns, but the ring dispenser is not empty. In such cases, the limited duration of the carousel ride has effectively forced an end to The Ring Game.

Who is the winner? Possibly every Best Strategist, possibly some, possibly none. A player has “won” if he/she has performed as well as possible; this means that, for each turn at the ring dispenser, a Real Player has chosen an action (Take or Pass) consistent with achieving the highest possible Point Score, given the current State of the Game. That optimal sequence depends on other players' actions, which jointly determine the State of the Game. By understanding The Ring Game, one will know whether or not they have achieved this goal.

IV. Rule Variation

When you have devised an Algorithm for solving the Apprentice-Level Ring Game, try this rule variation. After having decided the maximum number of Rotations, allow the last one to be incomplete: some playing position other than the last one may have the final move. To effect this, use the same silver ring cards that determine playing positions to decide which one should have the final move on the last rotation. Shuffle the silver ring cards face downward and pick one—that position number will have the final move, unless the game has terminated beforehand. This variation generally makes the Apprentice-Level game more competitive, and it helps to fix ideas for Squire-Level play.

You can also modify another of the three basic parameters, the point value for the gold ring. Instead of specifying a specific value, use a formula to determine the premium for securing the gold ring. For example, let the value of the gold ring be proportional to the number of silver rings taken by the player who secures it. The proportionality factor might be one, in which case the gold ring is equal to the sum of silver rings, or 1.75 times the number of silver rings (75% more than the sum of silver rings). Hint #1: does this make it more likely that a Best Strategist will choose to take a silver ring as part of an optimal strategy? Hint #2: any such variation does not alter the form of the Algorithm, but does require a bit of algebra to achieve the appropriate criterion for passing or taking.

There are two rewards from solving the Apprentice-Level Ring Game. The first, and larger one, is the pleasure from learning and the joy of accomplishment. The second is that you are now ready to play at the Squire Level.

V. The Ring Game Web Site

Each table-top Ring Game has a unique registration number, which entitles its purchaser to a reduced-price membership at The Ring Game Web Site. There you can play online with others at the same skill level. After each individual game, online players receive Performance Ratings from The Ring Game Tournament Scribe. A Performance Rating indicates the proportion of “correct” moves a player has made in the most recent game, along with a list of error messages. A subscriber to The Ring Game Web Site can also open links to pertinent topics, participate in Ring Game Chat rooms, pose questions and submit proposed solutions. Once an online player achieves a cumulative Performance Rating above 85%, he/she can take a succession of online tests for promotion to the next skill level.

Attachments: Table-Top Version of The Ring Game

Squire-Level Playing Instructions

Introductory Remarks

The Squire-Level Ring Game explicitly incorporates randomness. By this we mean that the outcomes of certain events, although unknown in advance, are resolved according to known probabilities. Randomness is not synonymous with chaos. Most of the concepts you need to solve the Squire-Level Ring Game are now taught in fifth and sixth grades. The following material gives precise definitions to commonsense notions such as “odds”, “likelihood” and “expected number”, terms that originated with games of chance.

Begin by considering a particular Random Event, a single flip of a “fair” coin. If we preclude the possibility of the coin's landing on its edge, there are only two possible results from this trial: either a “head” turns up, or a “tail” does. The probability of a “head” plus the probability of a “tail” equals 1, because either one or the other outcome is certain to occur. A “fair” coin is one that is perfectly balanced, i.e., neither a “head” nor a “tail” is more likely to appear. Since these two Probabilities are equal and sum to 1, the probability of a “head” must be ½=0.5, and the probability of a “tail” must be ½=0.5. The “odds” of a “head” relative to a “tail” is the ratio of the Probabilities, 1/2 divided by 1/2, or 1/1 (one-to-one).

Suppose you play the following coin flip game: you gain one point (score +1) if you correctly “call” (predict) the outcome; you lose one point (score −1) if the opposite side of the coin turns up. Is there a “calling” strategy you should follow? More precisely, on each turn, is there a procedure for deciding whether to choose “head” or “tail” so as to maximize your Expected Point Score?

The Expected Point score associated with any “call” is obtained by summing the products of Probabilities and their corresponding point scores. Suppose, for example, the coin is “fair” and you call “head”. The probability of a “head” turning up is 1/2, in which case you score +1 points; with equal probability the “tail” side appears, and you score −1 points. Summing the products gives your expected point score from calling “head”: ½(+1)+½(−1)=0. In other words, you expect to “break even in the long run” by calling “head”.

Can you do better by calling “tail”? The Probabilities are the same as before with the point scores reversed. With probability ½ a “head” appears, and you score −1 points; with probability ½ the flip yields a “tail”, and you score +1 points. The Expected Point Score from calling “tail”is ½(−1)+½(+1)=0, the same result as calling “head”. Neither strategy is dominant. Whether you always call “head”, always call “tail” or randomly alternate between the two makes no difference. This coin flip game, like the coin itself, is “fair”; no “strategy” is demonstrably superior or inferior.

Suppose, instead, that the coin is weighted to favor “heads”. However slight the bias, your optimal strategy is to call “head” every time. Still, a strategy which is best in an expected value sense may not do as well as an inferior one in any particular instance. Let the probability of a “head” be ⅗, which means the (complementary) probability of a “tail” is ⅖ (1−⅗). This is a very pronounced bias, since the “odds” of a “head” over a “tail” are 3 to 2 (⅗ divided by ⅖). Calling “head” each time produces an expected score of (⅗)(+1)+(⅖)(−1)=+⅕ point per flip. After a large number of flips, you should come out “ahead” by always calling a “head”. (ouch!) Calling “tail” each time produces an expected score of (⅗)(−1)+(⅖)(+1)=−⅕ point per flip.

Nevertheless, it is possible to get five tails in a row, in which case the optimal strategy produces an actual score of −5 points for those five flips. The inferior strategy of always calling “tail,” which has an Expected Point Score of −⅕ point per flip, would have yielded an actual score of +5 points for those five flips. The probability of getting five tails in a row is the probability of a single tail, ⅖, multiplied by itself four times. (⅖)(⅖)(⅖)(⅖)(⅖) equals 32/3125, about 1/100. The probability of five heads in a row, (⅗)(⅗)(⅗)(⅗)(⅗), equals 243/3125. This is a bit less than 8/100, a rather small probability, but nearly 8 times as large as the probability of five tails in a row.

It is because “bad things can happen to good strategies” that we evaluate strategies in terms of their Expected Point Scores. Understanding a problem, whether it arises from a strategy game or a real life situation, gives us the ability to associate outcomes and their likelihoods with a particular course of action. Only then is it possible to make an informed choice among alternatives.

There are three different sources of randomness in the three Squire-Level Games. In each game, players decide the Probabilities associated with outcomes of Random Events. The first Squire-Level game has a rule variation that is invoked with an agreed-upon probability. In game 2 there are pre-selected Probabilities that players get one additional turn in case the maximum number of rotations is exhausted. Game 3 features “clumsy” Always Takers: Artificial Players always try to “take” an available ring, but sometimes they miss.

The objective for Squire-Level Best Strategists is to effect a sequence of Takes and Passes which maximizes their Expected Point Scores. An optimal strategy is one which, “on average”, produces the best results. Of course, “going with the odds” is no guarantee of success on any particular trial: a coin biased in favor of “heads” may sometimes turn up “tails”. Nevertheless, over a protracted series of Squire-Level Ring Games, you can expect to maximize your average point score if you adopt a strategy that, in each game, maximizes your Expected Point Score.

Squire-Level Playing Instructions

Game 1: Rule Refinement

This Squire-Level game requires at least three Real Players, not all of them Best Strategists; the final Rotation may be complete or incomplete. The novel feature is the constraint imposed on Best Strategists whenever three conditions are met. Otherwise, Best Strategists remain free to Take or to Pass, as they choose. The Rule Refinement is in force provided: (1) there are at least two Best Strategists in adjacent playing positions, and that the Best Strategist whose turn it is has a Successor who is also a Best Strategist; (2) the Rotation in question is not the final one; (3) there are exactly N−1 silver rings in the ring dispenser, where N is the number of players (the sum of Best Strategists and Always Takers).

Note that consecutive Best Strategists may have their turns on different Rotations. This is because the Predecessor to playing position #1 is the playing position having the last move on the previous Rotation. When both of these positions are occupied by Best Strategists, condition (1) is satisfied. It is possible, of course, that the Run of Best Strategists is longer than two playing positions.

Before stating the Rule Refinement, let us give a precise definition to the expression, Run. A Run is a succession of two or more Best Strategists in adjacent playing positions. By assumption, Squire-Level Game 1 has at least one Always Taker. Consequently, a Run necessarily has a Terminus, a playing position occupied by a Best Strategist whose Successor is an Always Taker. The Best Strategist whose turn activates the Rule Refinement can be located anywhere along the Run except at its Terminus. Of course, a given assortment of player types about the carousel may contain more than one Run, and these may be of different lengths.

Now for the Rule Refinement: besides the usual parameters, players specify during Set-Up the Probabilities that a Best Strategist is required to Take or to Pass, each and every time the above three conditions are met. When chance forces a Best Strategist to Take, remaining Best Strategists in the Run, including the one at the Terminus, are free to Take or to Pass. Alternatively, suppose that the Best Strategist whose turn activates the Rule Refinement is required to Pass. In that case, succeeding Best Strategists, excepting the one at the Terminus, are also required to Pass; the last Best Strategist in the Run is free to Take or to Pass.

For example, let N=5, and let the random assignment of players to positions result in a Run of three adjacent Best Strategists. Further, let the maximum number of rotations be 6. Suppose that on rotation #3, the first of the Best Strategists in the Run is at the ring dispenser, where there are N−1=4 silver rings atop the Gold one. These values satisfy the three conditions for invoking the Rule Refinement.

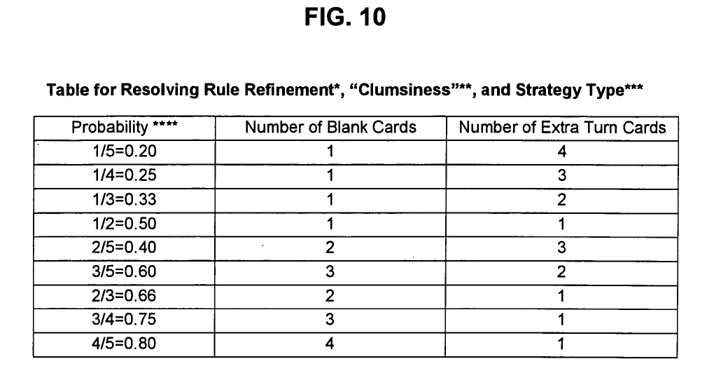

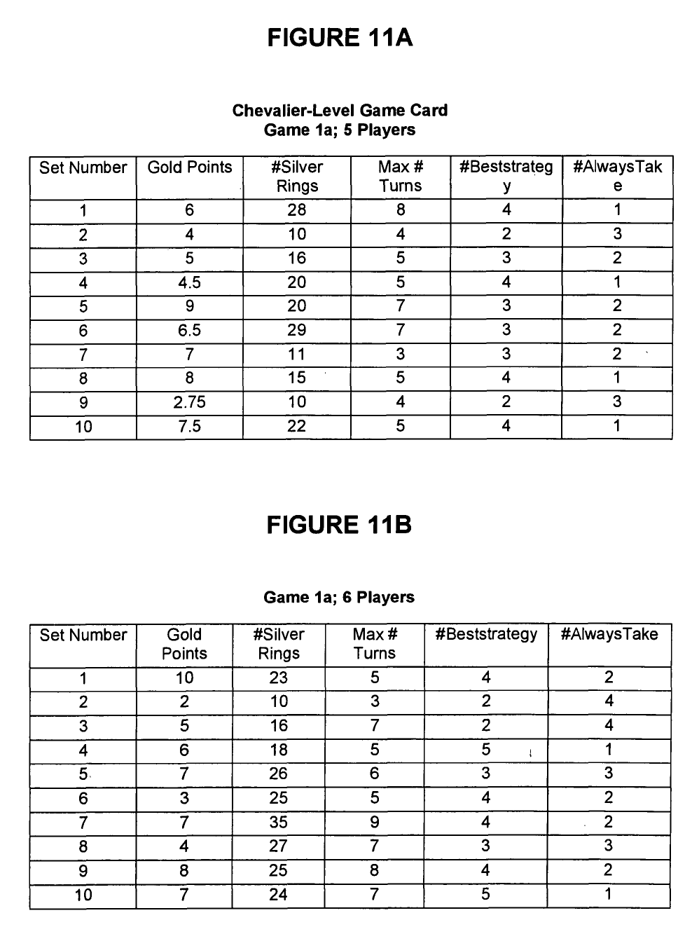

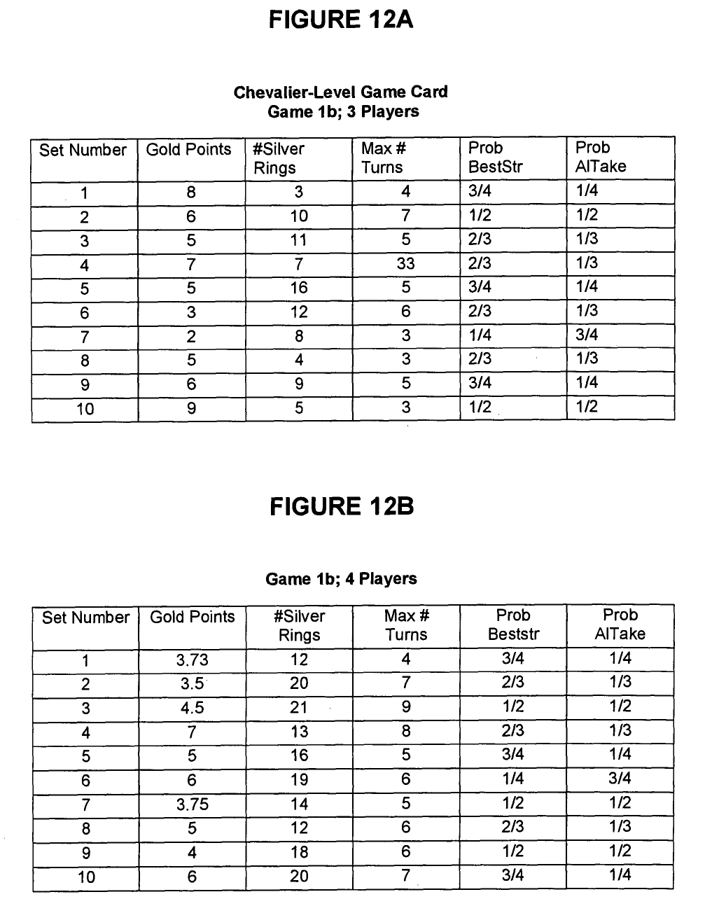

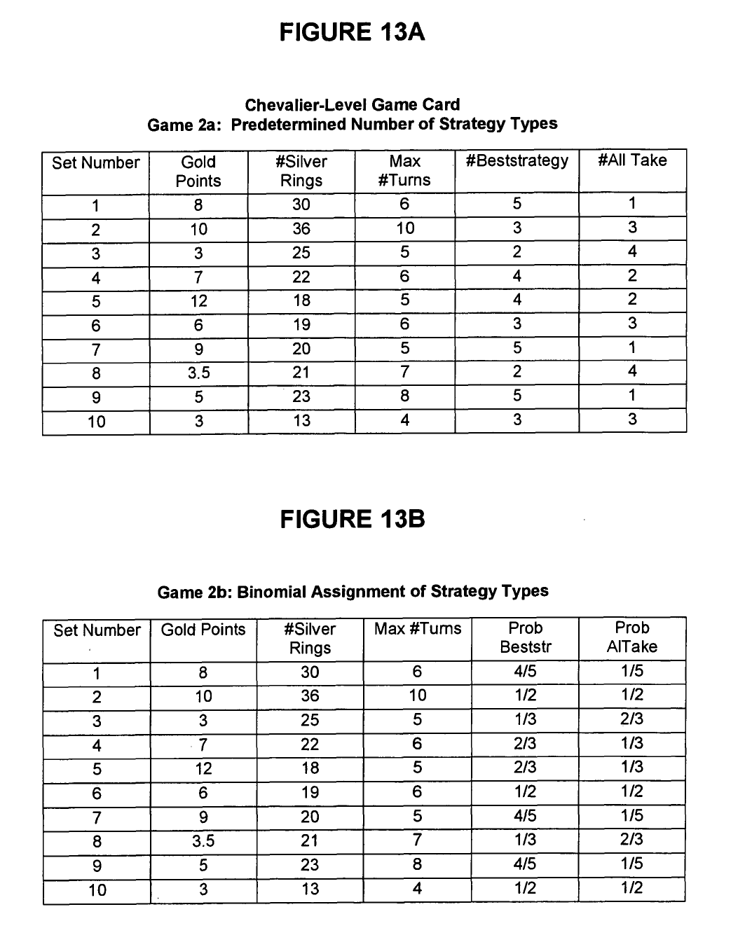

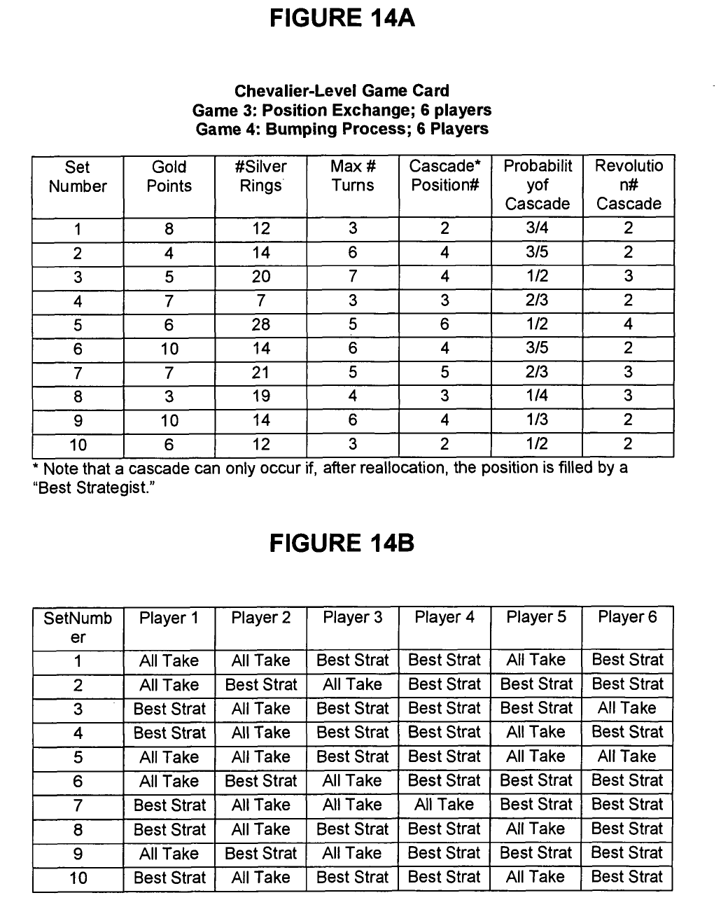

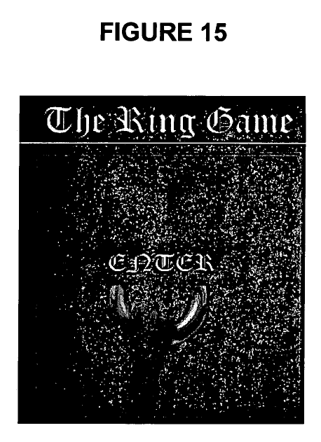

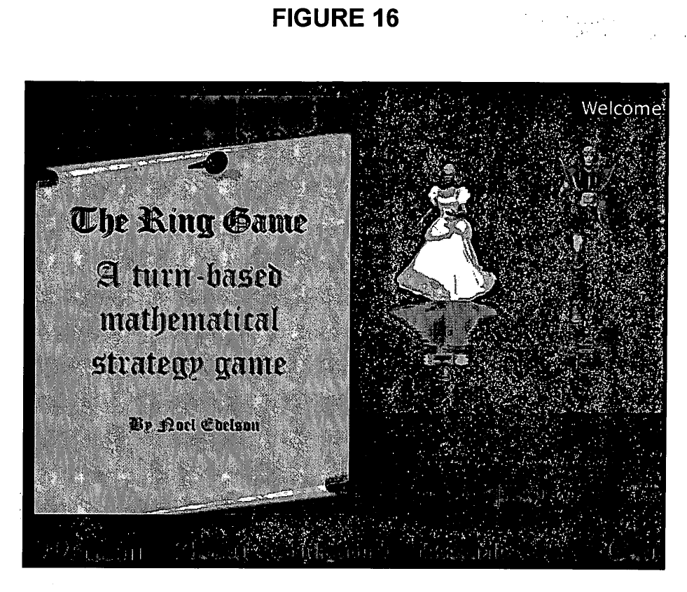

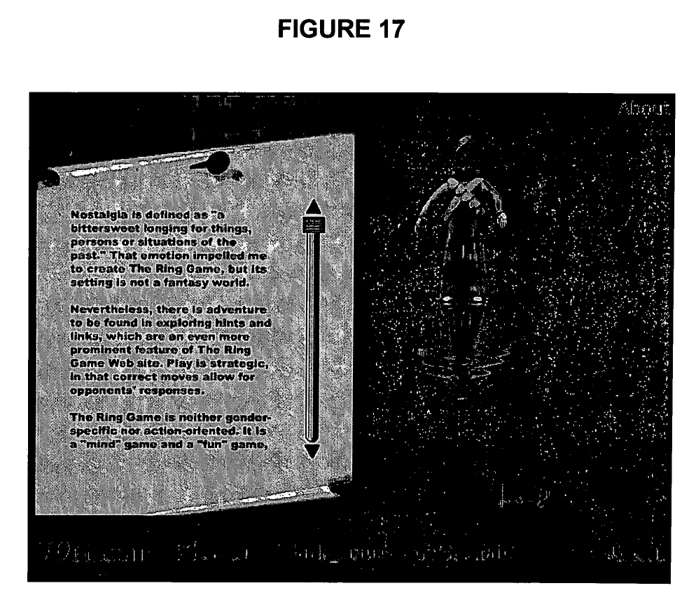

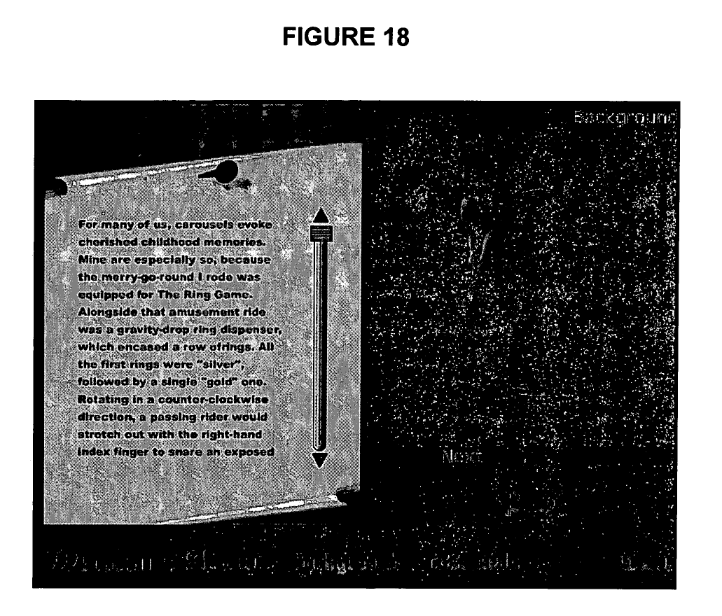

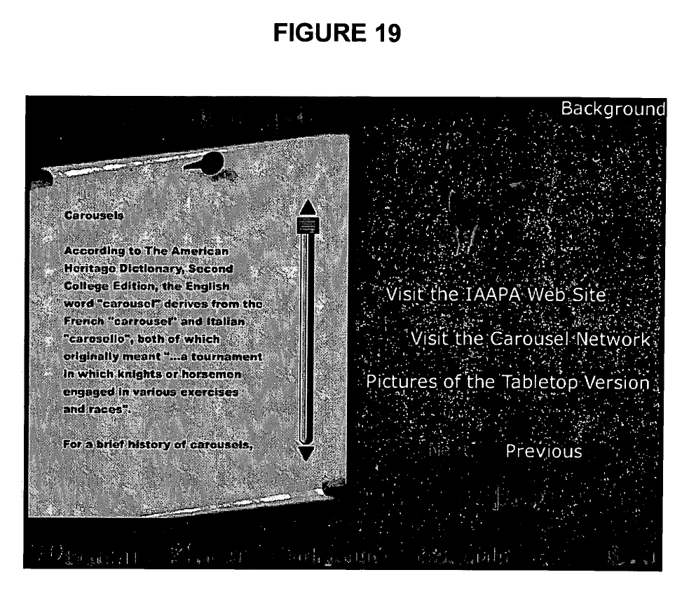

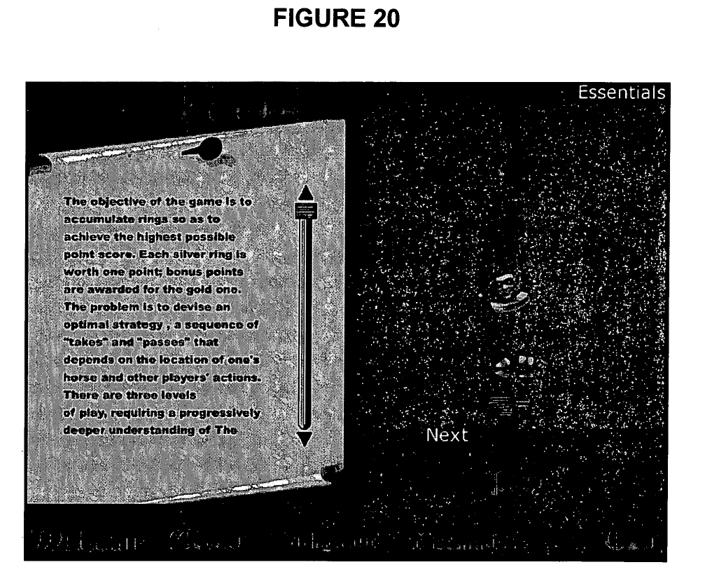

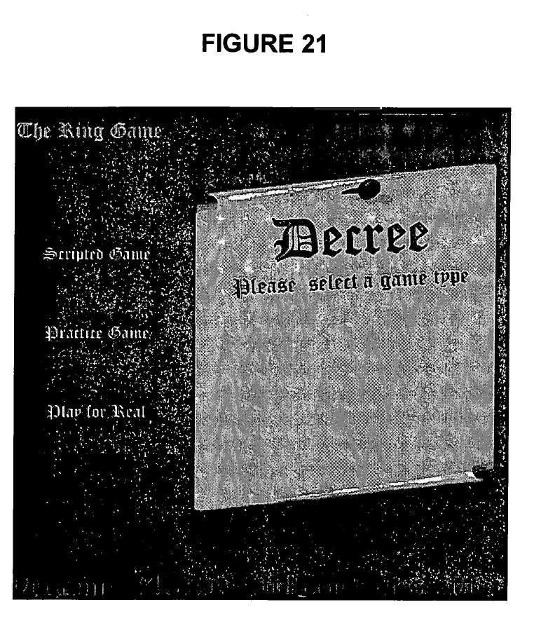

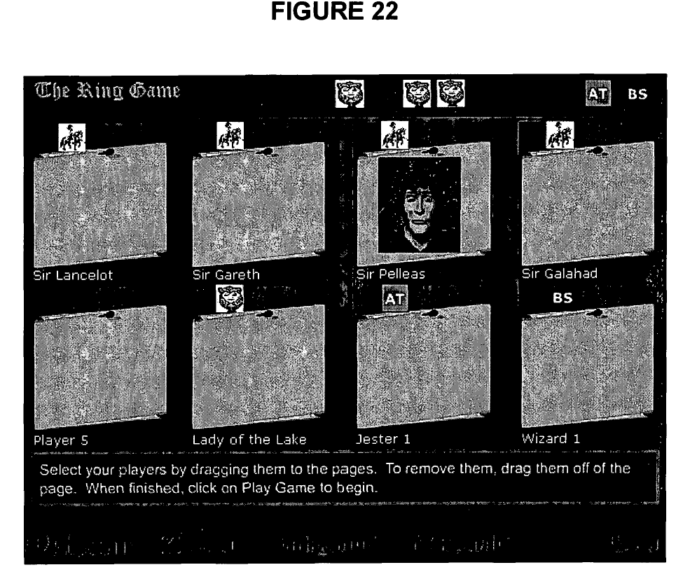

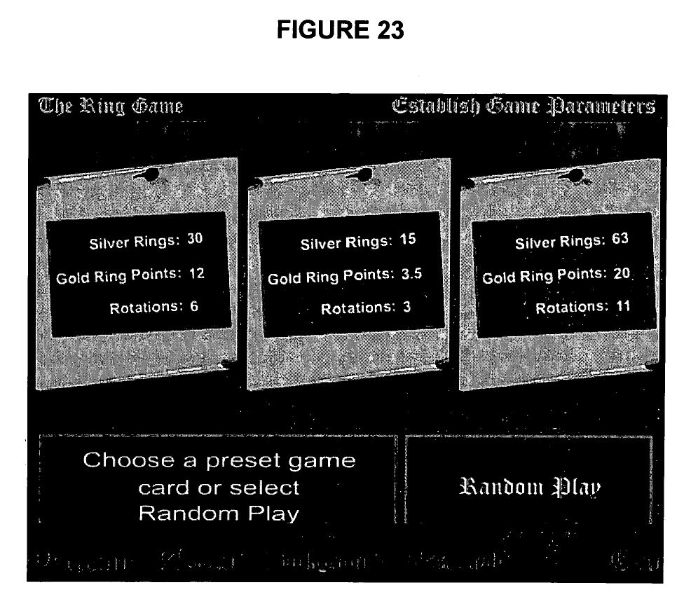

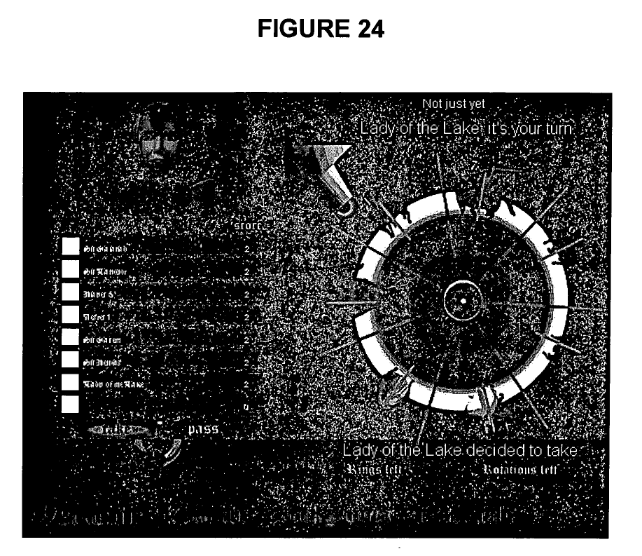

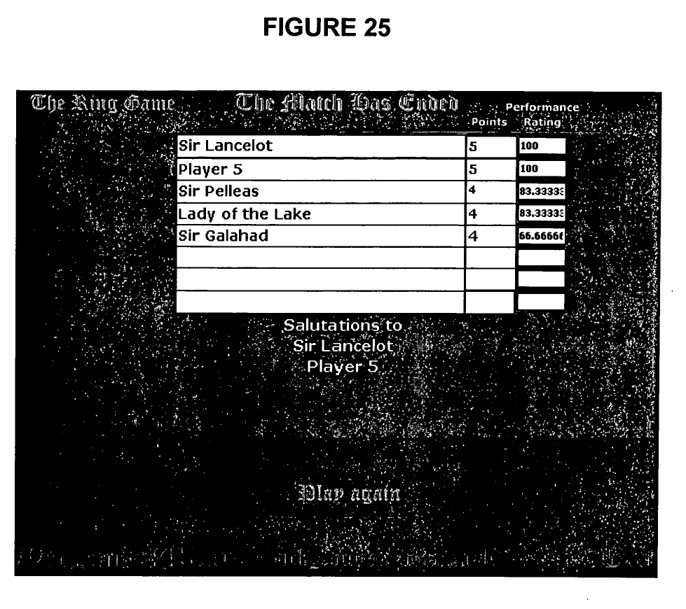

Suppose that during Set-Up Real Players have established ⅓ as the probability of a Forced Take; the alternative, a Forced Pass, has complementary probability ⅔(1−⅓). The Random Event is resolved by a procedure specified in the “Table for Resolving Rule Refinement . . . ”, such as shown in FIG. 10. On average, one-third of the times the Rule Refinement is invoked the first Best Strategist in the Run will be required to Take; the second Best Strategist in the Run is then free to Take or to Pass, there being three silver rings in the ring dispenser when it is his/her turn. On average, two-thirds of the times the first Best Strategist will be required to Pass, obliging the next Best Strategist in the Run to do likewise; the third Best Strategist, who is at the Terminus, is free to Take or Pass, with the ring dispenser still containing 4 silver rings.

I. Set-Up

Initial steps are the same as in the Apprentice-Level Ring Game. Insert the hexagonal decorative Center Panel into the carousel base. Decide the number of players, both Real Best Strategists and Artificial Always Takers, and choose a carousel horse for each.

The first few times you should play Squire-Level Game 1 with a complete Final Rotation, i.e., with the playing position #N having the final move. Later you can relax this assumption if you wish, but be sure to specify the player who gets the final turn on the Final Rotation.

Use Game cards or your own values for the usual three parameters: (1) number of silver rings; (2) number of gold ring points; (3) maximum number of Rotations. Place the appropriate number of silver rings on the ring dispenser above the gold ring. From the first column of the “Table for Resolving Rule Refinement . . . ”, choose the probability for a Forced Take provided all three ancillary conditions are met. Players can ignore the Rule Refinement only if the random assignment of players to positions produces no Run of consecutive Best Strategists. In that instance, Squire-Level Game 1 reduces to an Apprentice-Level game.

Otherwise, players must be sure to invoke the Rule Refinement if the game evolves to a critical point: it is not the Final Rotation; there are N−1 silver rings in the ring dispenser; it is the turn of one of a Run of Best Strategists whose Successor is also a Best Strategist. The second and third columns of the “Table for Resolving Rule Refinement . . . ” show combinations of Random Event cards that decide whether a Forced Take or a Forced Pass is to occur.

As with Apprentice-Level play, use consecutively numbered silver rings remaining cards to determine the order of taking turns. Insert Strategy/Identity cards into their appropriate slots on the Center Panel. Arrange consecutive silver rings remaining and rotations remaining cards in reverse order, and place them face outwards in separate holders on the ring dispenser. Situate players' horses about the carousel perimeter, making sure they face “forwards” as the carousel rotates counter-clockwise. Rotate the carousel base so the horse in playing position #1 is opposite the ring dispenser. You are now ready to play the Squire-Level Ring Game 1.

II. Play

Play proceeds as in the Apprentice-Level game, with successive Takes and Passes determining the evolution of silver rings remaining and rotations remaining cards. The Ring Game continues until someone Takes the gold ring, or until each player has had the maximum number of allowable turns.

Suppose the three conditions for invoking the rule refinement are met: (1) it is the turn of a Best Strategist whose Successor is also a Best Strategist; (2) there are N−1 silver rings in the ring dispenser atop the Gold one; (3) the current Rotation is not the final one. Let the agreed-upon probability of a Forced Take be ⅓=0.33. Mix a “deck” of 1 Blank and 2 Extra Turn Random Event cards. Have the Best Strategist whose turn activates the Rule Refinement pick one card. If Blank, his/her move is a Forced Take; succeeding Best Strategists in the Run are allowed to Take or to Pass, as they choose. If the chosen card is an Extra Turn, that Best Strategist and all others in the Run save the last are required to Pass. The Best Strategist at the Terminus of the Run is free to Take or to Pass; he/she faces a ring dispenser containing N−1 silver rings, the same number as when the Rule Refinement was invoked.

III. Computing Point Scores

Point scores are counted exactly as in Apprentice-Level play.

IV. Technical Analysis and Hints

We introduce the Rule Refinement to deal with phenomena best described as Passing Cascades. Players promoted to Squire rank will surely have encountered these in Apprentice-Level play. The procedures to be followed in cases of Forced Takes and Forced Passes are designed with one purpose in mind: to resolve some of the ambiguity in Apprentice-Level play when there is a Run of Best Strategists.

Admittedly, the Rule Refinement is a contrivance with no counterpart in reality. A more telling criticism is that it does not entirely remove the ambiguity inherent in Passing Cascades. On the other hand, the Rule Refinement helps to fix ideas for Squire-Level Game 2, which models a feature of carousel rides that is both realistic and strategically interesting.

Hint 1: Can you explain why we require that there be at least three Real Players for Squire-Level Game 1? Strategic interaction in the Apprentice-Level Ring Game requires at least two Real Players, though one can learn aspects of the elementary game by practicing against a single Always Taker.

Hint 2: How would you modify the rule refinement to cover games with all Best Strategists?

Squire-Level Playing Instructions

Game 2: Uncertain End Point

I. Set-Up

Initial steps are the same as in the Apprentice-Level Ring Game. Insert the hexagonal, decorative Center Panel in the carousel Base. Decide the number of players, both real and artificial, and choose a carousel horse for each.

An implicit assumption is that the final Rotation is a complete one, i.e., that the player in the last position has the final move. We suggest variations on this assumption in section V below.

Squire-Level Game 2 can be played with as few as two and as many as six players. Since this game introduces a random element, and you may not be used to computing Probabilities, begin practicing against a single Artificial Always Taker. Use the Game cards for Squire-Level Game 2 to establish parameter values, or create your own.

The upper portion of each Squire-Level Game Card, labeled “Game Values”, displays ten rows of recommended parameter sets: (1) number of silver rings; (2) number of gold ring points; (3) maximum number of Rotations. After selecting a particular row, place that number of silver rings on the ring dispenser above the gold ring.

The lower portion of the Squire-Level Game Card has ten rows marked “Extra Turn Probabilities”. Use the same row number from this group as you did for “Game Values”. If you prefer, generate you own combinations of “Game Values” and “Extra Turn Probabilities”. Section II below explains how Random Event cards determine whether or not players get extra turns.

As with Apprentice-Level play, use consecutively numbered silver rings remaining cards to determine the order of taking turns. Insert Strategy/Identity cards into their appropriate slots on the Center Panel. Arrange consecutive silver rings remaining and rotations remaining cards in their customary reverse order, and place them face outwards in separate holders on the ring dispenser. Situate players' horses about the carousel perimeter; making sure they face “forwards” as the carousel rotates counter-clockwise. Rotate the carousel Base so that the horse in playing position #1 is opposite the ring dispenser. You are now ready to play the Squire-Level Ring Game 2.

II. Play

Play proceeds as in the Apprentice-Level game, with successive Takes and Passes determining the evolution of silver rings remaining and rotations remaining cards. The Ring Game continues until someone secures the gold ring, or until each player has had the maximum number of allowable turns.

Now for the novel feature of Squire-Level Game 2: the “final” rotation is not necessarily the last one. Suppose rings remain on the ring dispenser after the playing position with the Final Turn has had its last turn (note that the Zero Rotations remaining card should be tabled in front of the ring dispenser). That situation would represent a forced ending in the Apprentice-Level game, and players would compute their Point Scores. Instead, Squire-Level Game 2 players consult the appropriate row of Extra Turn Probabilities on their Game Card.

The first entry is the probability that playing position #1 gets an additional turn. If granted that reprieve, the “first-mover” Takes or Passes the available ring, knowing that this is his/her last opportunity to do so. Next to the “first-mover's” additional turn probability is a parenthesis which contains combinations of Random Event cards that are used to determine whether or not an additional turn materializes.

The next entry is the probability and parenthesis for the player in playing position #2. He/she gets an extra turn only if his/her Predecessor has gotten an additional turn, and there are still rings on the ring dispenser. There are “Extra Turn Probabilities” for all players, but no assurance that all will have an opportunity to exercise the option. If one player fails to get an extra turn at the ring dispenser, no Successor is eligible. Clearly, the likelihood of an Extra Turn is least for the Final-Mover. He/she cannot hope to access the ring dispenser again, unless all prior playing positions have done so.

To simulate Random Events, remove the prescribed number of “Blank” and “Extra Turn” Random Event cards. The procedure for resolving the extra turn option is as follows: mix the “Blank” and “Extra Turn” cards face downwards, and have the First-Mover choose one. If his/her chosen card is blank, the game is over; nothing remains but to compute scores in the usual fashion. By assumption there are still rings on the ring dispenser, so no one has yet secured the Gold. Scores are simply the number of silver rings on players' Ring Poles. Contrariwise, if the First-Mover draws an “Extra Turn” card, rotate the carousel so his/her horse is opposite the ring dispenser. The First-Mover then Takes or Passes the available ring.

Next, remove the Random Event cards for playing position #2, and repeat the above procedure. The game is over if the second card drawn is blank, while an “Extra Turn” card permits an additional turn. Continue until one of three contingencies transpires: (1) a player draws a blank card; (2) all players have had additional turns; or (3) available rings are exhausted, whichever happens first.

As we mentioned in Section I above, it is best to learn Squire-Level Game 2 with just two players, using the side of the Game Card that states “Play Me First”. The reverse side is a more complicated version, which incorporates a factor we call “Envy”. This is a penalty which reduces the score of the player whose opponent secures the gold ring. If neither player secures the Gold, no penalty points are assessed. “Envy” is implicitly zero on the “Play Me First” side, and never exceeds one point on the reverse side. Even so, “Envy” complicates strategic interactions. We only allow for “Envy” in head-to-head competition; there is no penalty assessment in games with more than two players.

After learning how to determine an optimal strategy in the face of “Envy”, try to explain why such a penalty would add nothing essential to the Apprentice-Level game. Would this also be the case if the “Envy” deduction exceeded one point?

III. Computing Point Scores

In games without “Envy”, scores are the same as in Apprentice-Level play. If you have played a two-person game with “Envy”, and one player has secured the gold ring, be sure to deduct the specified penalty from the other player's score. That deduction will always be less than one point, the value of a silver ring.

IV. Technical Analysis and Hints

This Squire-Level game incorporates all features of the Apprentice version, but adds a random element: the playing position that has had the last turn when the carousel ride actually ends. This modification is both realistic and enriching. Real carousel rides do not end abruptly. Instead, there is a gradual slowing of gear-linked music and rotation, so a rider cannot be certain whether his horse will stop beyond, at or before the ring dispenser. To capture this uncertainty we reinterpret the Apprentice-Level parameter value, “maximum number of turns.”

In the Apprentice-Level game, the carousel ride implicitly ends after the Final-Mover has gone past the ring dispenser on the Final Rotation. But the ring dispenser may be empty then, the gold ring having already been removed. That Take ends a Squire-Level Game 2 session, though the carousel ride may be imagined to continue past an empty ring dispenser.

Squire-Level Game 2 treats “maximum number of rotations” as a random variable. If the Final Rotation concludes with rings still remaining, the carousel may rotate enough so the player in the next playing position gets a final opportunity to Take or to Pass. When this is so, that player's Successor may also get an additional turn, provided there are still rings on the ring dispenser. But should any player fail to get an additional turn, no Successor is eligible. In effect, failing to get an additional turn is equivalent to the carousel's stopping before that player's horse reaches the ring dispenser.

We represent chances for additional turns by a sequence of conditional Probabilities, which are resolved by Random Event cards. The Probabilities can be as small as zero (no chance for an additional turn) or as large as one (certain to get an additional turn); they can be the same for all players, or no two Probabilities alike.

Let's illustrate the concept by a specific example with three players and a complete Final Rotation. Suppose ⅘ is the probability that the First-Mover has an additional turn, after all players have had their maximum number of turns. Choose ⅔ for the probability that playing position #2 gets an additional turn, given that the First-Mover has had one, and ½ for the probability that playing position #3 gets an additional turn, given that his/her Predecessor has had one. Of course, additional turns are interesting only if there are available rings.

To determine whether or not the First-Mover gets an additional turn, take one blank Random Event card and four marked “Extra Turn.” Shuffle the five cards face downward, and have the First-Mover choose one. Clearly, there are “four chances in five” for an extra turn; this is the commonsense meaning of the phrase “the probability of an extra turn is ⅘.”

If the First-Mover selects a blank card, he/she gets no additional turn, nor is anyone else eligible. The carousel has stopped after the last complete revolution, but before the horse in playing position #1 has reached the ring dispenser. Nothing remains but to compute players' point scores in the usual fashion. If the First-Mover instead selects an “Extra Turn” card, which is the more likely outcome given a probability of ⅘, rotate the carousel so his/her horse is opposite the ring dispenser. The First-Mover then Takes or Passes the available ring, knowing that there will be no subsequent reprieve.

Assuming the First-Mover has had an additional turn and there are rings remaining in the ring dispenser, playing position #2 has a chance for an additional turn. Take one blank random event card and two marked “Extra Turn.” The “second-mover” has “two chances in three” of selecting an “Extra Turn” card. Provided the First-Mover has had an additional turn, this procedure produces a conditional probability of ⅔ that the “second-mover” accesses the ring dispenser. An extra turn is conditional on the First-Mover's having had one. If the “second-mover” selects an “Extra Turn” card, rotate the carousel so his/her horse has an opportunity to Take or to Pass the available ring. Selecting a blank card, however, ends the game session.

Given that the first two players have had additional turns, and there are still rings available, the third player has his/her chance. Represent the conditional probability of ½ by two random event cards, one blank and one marked “Extra Turn.” The game session and ride conclude either by the Final-Mover's failing to get an additional turn, or by his/her decision to Take or Pass the available ring. Clearly, an optimal strategy in Squire-level Game 2 must allow for the option of additional turns.

It is important to distinguish between “conditional” and “unconditional” Probabilities in formulating an optimal strategy. These concepts are now taught in most 5th- or 6th-grade arithmetic classes. In our example, the unconditional probability that the second-mover has an additional turn is not ⅔. ⅔ is his/her probability of an additional turn, conditional on the First-Mover's having had one. The unconditional probability of the “second-mover's” having an additional turn is the probability that both the First-Mover and the “second-mover” jointly have additional turns. Similarly, the unconditional probability that the Final-Mover has an additional turn is the probability of all three players having additional turns.

You can play Squire-Level Game 2 without understanding this distinction; we list which combinations of Random Event cards to use in deciding extra turns. But you will not be able to play in an informed manner. Try to determine unconditional Probabilities for the second and third players in the above example. Hint: for the First-Mover, unconditional and conditional Probabilities are the same. Second hint: think about the probability of getting two “heads” in two flips of a coin, or the probability of getting a “head” in a single coin flip followed by rolling a “1” with a six-faced die. Third hint: what is the probability of rolling a “1” with a six-faced die, if you only get to roll when the prior coin flip comes up “heads”?

If you are still confused, do what adults do when flummoxed by a computer: ask a bright ten-year-old. Failing that, The Ring Game Web site provides further examples to help you compute unconditional from conditional Probabilities. And when you begin playing Squire-Level Game 2, do so using the “Play Me First” side of the 2-player Game Card.

V. Variations

Should they wish, players can implement the Apprentice-Level variation of an incomplete Final Rotation. In that case, extra turn chances apply to players after the one having the last move on the Final Rotation. Such extra turn chances are do not extend beyond playing position N on the Final Rotation.

Rather than having just one chance for an additional turn, players can agree to use conditional probabilities until someone draws a blank random event card. In that instance, it is possible, though rather improbable, for players to have more than one extra turn.

Squire-Level Playing Instructions

Game 3: “Clumsy” Always Takers

I. Set-Up

Initial steps are the same as in the Apprentice-Level Ring Game. Insert the hexagonal, decorative Center Panel in the carousel Base. Decide the number of players, both Real and Artificial, and place that number of horses about the carousel perimeter. Make sure horses face “forwards” as the carousel rotates counter-clockwise.

An implicit assumption is that the Final Rotation is a complete one, i.e., that playing position #N has the last move on the Final Rotation. There must be at least one Artificial Always Taker to distinguish this game from the corresponding Apprentice-Level game.

Players can use Apprentice-Level game cards or create their own values for three parameters: (1) the number of silver rings; (2) the number of gold ring points; (3) the maximum number of Rotations. The only additional parameter is the probability that an Always Taker “misses” a ring; for simplicity, we use the same probability for all Always Takers, i.e., no Artificial character is “clumsier” than another. With that simplification, you can use the “Table for Resolving Rule Refinement, Clumsiness . . . ” to resolve whether an Always Taker secures a ring. Instead of representing the probability of a Forced Take under the Rule Refinement, let the Table's first column represent the probability that a “clumsy” Always Taker secures the ring.

For example, if players agree that the likelihood of an Always Taker succeeding is ⅘, use four Blank and one Extra Turn cards. The “odds” that an Always Taker manages to secure a ring is 4 to 1; such Artificial players are not particularly clumsy. But if the chosen probability is less than 1/2, Always Takers can be expected to “miss” a ring more often than not.

II. Play

Play proceeds exactly as in the Apprentice-Level game, with successive Takes and Passes determining the evolution of silver rings remaining and rotations remaining cards.

Best Strategists choose whether to Take or to Pass, and always accomplish their intended actions; whether or not an Always Taker secures or misses depends on whether an Blank or an Extra Turn Random Event Card is drawn.

III. Computing Point Scores

These are computed in the normal fashion, with one point for each silver ring and the agreed-upon number of points for the gold ring.

IV. Technical Analysis and Hints

A rigorous solution with “clumsy” Always Takers is, computationally, very complex. Even an approximation to the full procedure requires an understanding of the binomial distribution, but the essential concepts are not difficult. What is required is an estimate of how many Takes “clumsy” Always Takers are likely to accomplish en route to a particular game ending. This is equivalent to the problem of estimating the number of “heads” that will turn up in a given number of flips, when you know the probability that each flip will produce a “head”.

You should begin playing Squire-Level Game 3 alone with a single Always Taker. Then, include additional Always Takers. Only then should you play against another Best Strategist, using either one or multiple Always Takers.

V. Variations

An obvious extension is to combine the three Squire-Level games in various mixes, say Games 1 and 2 or Games 2 and 3. How many ways are there to combine any two of the three games? Such combination are easy to devise, but may be difficult to solve.

Attachments: Table-Top Version of The Ring Game

Chevalier-Level Playing Instructions

Introductory Remarks

There are four Chevalier-level games, two featuring uncertain player identities and two featuring position changes. These are intended to be played with the full complement of six players, but the first two games can have as few as three. All players must be Real, although some may have to behave like Always Takers.

In the first two games, players use the “Table for Resolving Rule Requirement, “Clumsiness”, and Strategy Type” to determine whether they follow Best Strategy or Always Take. Each conceals his/her playing style from the others. Accordingly, a player inserts his/her strategy/identity card into the decorative canter panel with the blank side facing outwards. Players might prefer having an observer to moderate the strategy assignment process in Game 1, though that is not necessary. An impartial presence is required for Game 2, however, because its Set-Up phase also features a concealed position choice.

Games 3 and 4 bear a resemblance to “musical chairs,” and share its quality of “the more, the merrier.” Players use “Table for Resolving Rule Requirement, “Clumsiness” and Strategy Type” to determine whether they are to be Best Strategists or Always Takers, but the results are common knowledge. In Chevalier-Level Games 3 and 4, a player's strategy/identity card in the Center Panel reveals his/her type.

In Game 3 one player becomes Position-Chooser (p-c), who can exchange positions with anyone else. Play proceeds after the single position exchange. In Game 4, if the p-c selects another playing position, a Bumping Process may ensue: the player who is “bumped” can “bump” another. The Bumping Process continues, subject to the condition that a player can only claim another position if its occupant has not previously been “bumped.” Play proceeds from the termination point. Games (3) and (4) incorporate the Rule Refinement of Squire-Level Game 1.

Chevalier-Level Playing Instructions

Game 1: Uncertain Playing Strategies

This game comes in two versions, 1a and 1b, which differ only in the random procedure for assigning strategy types. Both versions require at least three Real Players. Generally, the fewer the number of players, the easier it is to determine optimal strategies. Players can use Apprentice-Level Game cards or mutual consent to establish values for: (1) number of silver rings; (2) number of gold ring points; and (3) maximum number of (complete) Rotations.

Version 1a: Predetermined Number of Strategy Types

I. Set-Up

After choosing the usual three parameter values, players place the agreed-upon number of silver rings on the ring dispenser atop the single Gold one. They then decide how many Best Strategists there are to be, and how many Always Takers. Both types must be represented, for when all are Best Strategists there is no uncertainty, and the game reverts to Apprentice-Level. Strategic interaction requires at least two Best Strategists. Therefore, with only three players, there must be exactly two Best Strategists and one Always Taker.

Remove a number of Best Strategist Strategy/Identity cards equal to the agreed-upon number of that type, and the same for Always Takers. Mix that “deck”, and deal out the cards face downwards. Each player conceals how he/she will play from the others. Use consecutively numbered silver rings remaining cards to determine the order of taking turns. Players insert their Strategy/Identity cards, blank side outwards, into their assigned slots of the Center Panel. After silver rings remaining and rotations remaining cards are in their holders on the ring dispenser, and players situate their horses about the carousel perimeter, Set-Up is complete. Rotate the carousel so the horse in position #1 is opposite the ring dispenser, and begin play.

II. Play

Play proceeds exactly as in the Apprentice- and Squire-level games. If necessary, refer to either of these instruction sets.

Players' moves may eventually reveal their strategy types, but Best Strategists generally have to make decisions in the absence of full information. Knowing how many opponents are of each type just establishes the probability that any particular opponent will be a Best Strategist. The objective is the same as in Squire-Level play: Best Strategists should plan moves so as to maximize their expected point scores.

III. Computing Point Scores

These are computed in the normal fashion, with one point for each silver ring and the agreed-upon number of points for the one who secures the gold ring.

IV. Technical Analysis and Hints

Refer to Squire-Level Playing Instructions, Introductory Remarks, for a review of how to compute Expected Point Scores.

Hint: Begin with 3-person games of Version 1a. After several sessions, compare the structures of Squire- and Chevalier-Level games. Do the probabilities of “extra turns”, which appear in Squire-Level games, affect strategy choices in the same way as the probability of an opponent playing Best Strategy in Chevalier-Level games? Or is the Rule Refinement of Squire-Level Game 1 more analogous to uncertain playing strategies?

Version 1b: Binomial Assignment of Strategy Types

1. Set-Up

Players establish values for three parameters, using either Apprentice-Level Game cards or their own suggestions. After deciding on the probability of being a Best Strategist, consult the “Table for Resolving Rule Refinement, “Clumsiness” and Strategy Type” for the proper number of Best Strategist and Always Taker cards. For example, if the probability of being a Best Strategist is ¾, select three Best Strategist and one Always Taker cards. Mix that “deck” face downwards, have a player draw one card, note its type, and return his/her card to the “deck”. If players wish, a non-playing observer can supervise this process.

Return the Best Strategist and Always Taker cards to their respective piles. Players assume assigned roles by selecting an appropriate Strategy/Identity card. They do so in a fashion which conceals that choice from other players, placing their Strategy/Identity cards face-down in front of themselves. Use consecutively numbered silver rings remaining cards to determine the order of taking turns. Players then insert their Strategy/Identity cards, blank side outwards, in their assigned slots of the ring dispenser. After silver rings remaining and Rotations remaining cards are in their holders on the ring dispenser, and players situate their horses about the carousel perimeter, Set-Up is complete. Rotate the carousel so the horse in Playing Position #1 is opposite the ring dispenser, and begin play.

In any particular game, the actual number of Best Strategists and Always Takers is unknown; the breakdown of strategy types is a random variable with a Binomial probability Distribution. Conceivably, all players might be of the same type, in which case the game is Apprentice-Level, though players do not know this beforehand. Everyone playing Best Strategy uses the same probability for an opponent's type, and plans his/her moves accordingly. The (common knowledge) probability value is established when players select the prescribed number of Best Strategy and Always Take cards.

II. Play

Play proceeds exactly as in the Apprentice- and Squire-level games. If necessary, refer to either of these instruction sets.

Players' moves may eventually reveal their strategy types, but Best Strategists generally have to make decisions in the absence of full information. Knowing how many opponents are of each type just establishes the probability that any particular opponent will be a Best Strategist. The objective is the same as in Squire-level play: Best Strategists should plan moves so as to maximize their expected point scores.

III. Computing Point Scores

These are computed in the normal fashion, with one point for each silver ring and the agreed-upon number of points for the one who secures the gold ring.

IV. Technical Analysis and Hints

Refer to Squire-level Playing Instructions, Introductory Remarks for a review of how to compute Expected Point Scores when outcomes are random. Players must evaluate the Expected Point Scores associated with alternative strategies.

Chevalier-Level Playing Instructions

Game 2: Location Choice With Uncertain Identities

This game requires a moderator, and can be played either with a predetermined proportion of strategy types (Version 2a) or a Binomial assignment procedure (Version 2b).

I. Set-Up

Players choose values for three parameters: (1) number of silver rings; (2) number of gold ring points; (3) maximum number of (complete) Rotations. Place the single gold ring on the ring dispenser, and on top of it the agreed-upon number of silver rings.

Players then meet individually with the moderator who, using the appropriate number of Best Strategist and Always Taker cards, informs them which roles they are to assume. During that initial session, the moderator randomly advises one player who draws a Best Strategist card that he/she also gets to select his/her playing position. We call the player so designated the “p-c” (Position-Chooser). With Version 2b, it is possible that no one has drawn a Best Strategist card before the last player meets with the moderator. In that case, the moderator assigns Best Strategist and p-c status to the final player.

The p-c advises the moderator which playing position he/she wants to occupy. That selection is concealed from the other players, each of whom is aware that someone else has made such a choice. In Version 2a the p-c chooses a playing position knowing only the numbers of Best Strategists and Always Takers, not their playing positions. With a Binomial assignment procedure, the p-c knows only the probability that any given opponent is a Best Strategist or an Always Taker.

Players meet individually with the moderator for a second time, when each receives a Strategy/Identity card and a playing position. Dispensing Strategy/Identity cards is merely a formality, since the moderator already knows whether a player is to be a Best Strategist or an Always Taker. Determining the order of taking turns requires that the moderator allow for the first-round decision of the p-c. The moderator does so by removing the silver rings remaining Card corresponding to the playing position reserved for the p-c, mixes the other silver rings remaining cards, and places them in a pile face downwards. For players other than the p-c, the moderator uses the top card in the pile to assign playing positions.

Afterwards, players insert their Strategy/Identity cards, blank sides outward, in their assigned slots of the Center Panel. The moderator places silver rings remaining and Rotations remaining cards in their holders on the ring dispenser. Players situate their horses facing “forwards” about the carousel perimeter, and rotate the carousel Base so playing position #1 is opposite the ring dispenser. Play can then begin.

II. Play

Play proceeds exactly as in the Apprentice- and Squire-level games. If necessary, refer to either of these instruction sets.

Players' moves may eventually reveal their strategy types, but Best Strategists generally have to make decisions in the absence of full information. Knowing how many opponents are of each type just establishes the probability that any particular opponent is a Best Strategist or an Always Taker. The objective is the same as in Squire-level play: Best Strategists should plan moves so as to maximize their expected point scores.

III. Computing Point Scores

These are computed in the normal fashion, with one point for each silver ring and the agreed-upon number of points for the one who secures the gold ring.

IV. Technical Analysis and Hints

The p-c selects a playing position knowing only the probabilities that any other location is occupied by a Best Strategist or an Always Taker. The chosen playing position must be one that produces the greatest expected point score. But other Chevalier-Level players should be capable of making the same calculations, and they will plan their strategies expecting that position to be occupied by a Best Strategist. So the p-c must take account of opponents' reactions in making his/her selection . . .

Chevalier-Level Playing Instructions

Game 3: Position Exchange

Chevalier-Level Game 3 shares features with both Chevalier-Level Games 2 and 4. Like Game 2, Game 3 has a designated p-c. Unlike Game 2, however, a Real Player assigned the role of Always Taker can become the p-c; furthermore, strategy types are known. Like Game 4, there may be a Position Exchange. The designated p-c can change places with any other player, and play proceeds with that revised allocation of playing positions. The p-c's choice depends on whether he/she is a Best Strategist or an Always Taker.

To make the relocation decision unambiguous, Chevalier-Level Game 3 uses the Rule Refinement from Squire-Level Game 1: if three conditions are met, the first in a Run of Best Strategists is forced either to Take or to Pass.

I. Set-Up

Players specify the usual three parameters: (1) number of silver rings; (2) number of gold ring points; and (3) maximum number of Rotations. This can be accomplished using Apprentice-Level Game cards or by consensus. Place the agreed-upon number of silver rings on the ring dispenser atop the single Gold one, and choose horses. Players agree on the distribution of strategy types, and select the appropriate number of Best Strategist and Always Taker cards. Mix these, and deal one to each player. Expose the Strategy/Identity cards, and use silver rings remaining cards to determine the initial order of taking turns. If they wish, Best Strategists can select another Strategy/Identity card of the same type with a preferred namesake.

Players insert their Strategy/Identity cards, face sides outward, in their assigned slots of the Center Panel. Once silver rings remaining and rotations remaining cards are in their holders on the ring dispenser, and players' horses are opposite their Strategy/Identity cards, the stage is set for Position Exchange.

Take one Extra Turn card and a number of Blanks so that altogether they equal the number of players. Mix and deal the Random Event cards; the player who gets the Extra Turn card is the designated p-c. That individual decides whether or not to exchange positions with another player. Afterwards, the horse in playing position #1 is situated opposite the ring dispenser, and play begins.

II. Play

Play proceeds as in Squire-Level Game 1. If all three conditions are met, the Rule Refinement governing Forced Takes and Forced Passes is invoked.

III. Computing Point Scores

These are computed in the normal fashion, with one point for each silver ring and the agreed-upon number of points for the one who secures the gold ring.

IV. Technical Analysis and Hints

The p-c chooses a playing which maximizes his/her expected point score. That choice will generally be different for a Best Strategist and an Always Taker. The Rule Refinement will be especially relevant for the former.

Chevalier-Level Playing Instructions

Game 4: Repositioning Via Bumping Process

This version is like Game 3, except for the repositioning procedure. Like Game 3, the designated p-c can be either a Best Strategist or an Always Taker, and is selected in the same manner. That individual can elect to stay in his/her initial playing position, or exchange places with any other player. But now the player displaced by the p-c is allowed to “bump” anyone else except the p-c. “Bumping” continues, subject to the condition that a displaced player can relocate to any position except one occupied by a previously “bumped” player. In effect, “bumped” players get “tenure” in the positions previously occupied by the player who “bumped” them.

A forward-looking player will select a position, mindful of the effect on game outcome of subsequent repositionings. The objective is to select a playing position that maximizes one's expected point score, given the distribution of strategy types when “bumping” terminates. The Rule Refinement is invoked during play if all three conditions are satisfied.

Besides the requirement that a previously “bumped” player cannot be dislodged a second time, we impose another condition on the “bumping” process. While not essential, this condition makes the “bumping” process more elegant. The condition has two parts: (1) a player must choose an available position that maximizes his/her expected point score, given the distribution of strategy types that will prevail once “bumping” ends; (2) should there be more than one position affording the same expected point score, a “bumped” player must choose the unoccupied one.

If observed, this condition precludes purely “spiteful” behavior; by this we mean choosing a position that is less desirable than another, just because doing so damages a particular player. In addition, this condition terminates the “bumping” process at a point where further repositionings do not change the game outcome.

There is a difficulty in enforcing this two-part condition, however: being able to anticipate the final distribution of strategy types is the essence of Game 4. A “wrong” move by one player can, and typically will, lead to a different final distribution than the “right” move. Nothing is lost but elegance, however, if the condition is not properly enforced. It is the first requirement, granting “tenure” to previously “bumped” players, that is important.

I. Set-Up

The procedure is the same as for Chevalier-Level Game 3 until the p-c decides whether or not to relocate. If the p-c stays put, Game 4 is the same as Game 3: play begins from that point, and the game is Squire-Level Game 1. If the p-c elects to “bump” another player, repositioning continues until a “bumped” player chooses to stay put, or until there are no “untenured” positions.

II. Play

Play proceeds as in Squire-Level Game 1. If all three conditions are met, the Rule Refinement about forced “takes” and “passes” is invoked.

III. Computing Point Scores

These are computed in the normal fashion, with one point for each silver ring and the agreed-upon number of points for the one who secures the gold ring.

IV. Technical Analysis and Hints

It is possible to play Game 4, even if players occasionally act “spitefully” and if they sometimes prolong the Bumping Process to no purpose. Part of the learning process is becoming able to identify those violations in post-mortem analyses of Game 4.

Hint: It is not “spiteful” behavior if a displaced player, to maximize his/her expected point score, relocates to a position that lowers the expected point score of another. This is so even if the adversely affected player is the one who “bumped” him/her. The occupant of the devalued position simply chose unwisely by not anticipating a rational decision by the “bumped” player.

Table for Resolving Rule Refinement*, “Clumsiness”**,
and Strategy Type***

| probability**** | Number of Blank Cards | Number of Extra Turn Cards |
|---|---|---|
| 1/5 = 0.20 | 1 | 4 |
| 1/4 = 0.25 | 1 | 3 |
| 1/3 = 0.33 | 1 | 2 |
| 1/2 = 0.50 | 1 | 1 |
| 2/5 = 0.40 | 2 | 3 |
| 3/5 = 0.60 | 3 | 2 |
| 2/3 = 0.66 | 2 | 1 |
| 3/4 = 0.75 | 3 | 1 |
| 4/5 = 0.80 | 4 | 1 |

*Rule Refinement: Squire-Level Game 1; Chevalier-Level Games 3 and 4
**“Clumsiness: Squire-Level Game 3
***Strategy Type: Chevalier-Level Games 1 and 2
****For Rule Refinement: probability of a forced “take”; complementary probability for a forced “pass”

For “Clumsiness: probability of an unintentional “miss”; complementary probability for a successful “take”

For “Strategy Type”, use “Best Strategist” and “Always Taker” cards instead of Blank and Extra Turn cards

Examples of suitable game cards will now be given.

Apprentice-Level Game Card for 5-Player Games:

| Set | | | |
|---|---|---|---|
| Number | Gold Ring Points | Number Silver Rings | Maximum # Turns |
| 1 | 2 | 11 | 8 |
| 2 | 4 | 30 | 7 |
| 3 | 8 | 39 | 10 |
| 4 | 1.5 | 22 | 8 |
| 5 | 7 | 28 | 9 |
| 6 | 9 | 33 | 7 |
| 7 | 10 | 12 | 3 |
| 8 | 5 | 18 | 6 |
| 9 | 6 | 17 | 5 |
| 10 | 3 | 36 | 11 |

Squire-Level Game Card for 2-Player Games—Play Me First

As game values:

| Set | | | Maximum |
|---|---|---|---|
| Number | Gold Ring Points | Number Silver Rings | # of Turns |
| 1 | 5 | 6 | 4 |
| 2 | 8 | 11 | 8 |
| 3 | 6 | 8 | 4 |
| 4 | 4 | 12 | 7 |
| 5 | 3 | 6 | 5 |
| 6 | 4 | 7 | 9 |
| 7 | 5 | 9 | 7 |
| 8 | 5 | 9 | 6 |
| 9 | 6 | 5 | 3 |
| 10 | 3 | 10 | 6 |

Next, a table of Extra Turn Probabilities* will be shown:

| Set | | |
|---|---|---|
| Number | Player #1 | Player #2 |
| 1 | 4/5 (1 blank, 4 Extra Turn) | 1/2 (1 blank, 1 Extra Turn) |
| 2 | 1/4 (3 blank, 1 Extra Turn) | 1/8 (7 blank, 1 Extra Turn) |
| 3 | 1/9 (8 blank, 1 Extra Turn) | 1/9 (8 blank, 1 Extra Turn) |
| 4 | 7/8 (1 blank, 7 Extra Turn) | 1/7 (6 blank, 1 Extra Turn) |
| 5 | 3/10 (7 blank, 3 Extra Turn) | 3/10 (7 blank, 3 Extra Turn) |
| 6 | 3/4 (1 blank, 3 Extra Turn) | 2/3 (1 blank, 2 Extra Turn) |
| 7 | 1/6 (5 blank, 1 Extra Turn) | 1/6 (5 blank, 1 Extra Turn) |
| 8 | 3/5 (2 blank, 3 Extra Turn) | 1/6 (5 blank, 1 Extra Turn) |
| 9 | 1/2 (1 blank, 1 Extra Turn) | 1/4 (3 blank, 1 Extra Turn) |
| 10 | 2/3 (1 blank, 2 Extra Turn) | 2/3 (1 blank, 2 Extra Turn) |

*The probability for the second player is conditional on Player #1's having had a turn.

Next, a Squire-Level Game Card for 2-Player Games with an “Envy” Penalty is

Game Values

| Set | Gold | # of | “Envy” | |
|---|---|---|---|---|
| Number | Ring Points | Silver Rings | Penalty | Maximum # Turns |
| 1 | 8 | 7 | 1/10 | 7 |
| 2 | 7 | 10 | 1/2 | 6 |
| 3 | 6 | 6 | 1/4 | 5 |
| 4 | 3 | 6 | 1/8 | 5 |
| 5 | 10 | 5 | 1/3 | 3 |
| 6 | 4 | 9 | 3/5 | 5 |
| 7 | 2 | 7 | 1/4 | 4 |
| 8 | 9 | 8 | 1/2 | 6 |
| 9 | 4 | 4 | 1/3 | 4 |

The following table shows Extra Turn Probabilities*:

| Set Number | Player # 1 | Player # 2 |
|---|---|---|
| 1 | ¾ (1 blank, 3 Extra Turn) | ½ (1 blank, 1 Extra Turn) |
| 2 | ⅔ (1 blank, 2 Extra Turn) | ⅛ (7 blank, 1 Extra Turn) |
| 3 | ⅓ (2 blank, 1 Extra Turn) | ¼ (3 blank, 1 Extra Turn) |
| 4 | ⅕ (4 blank, 1 Extra Turn) | ⅙ (5 blank, 1 Extra Turn) |
| 5 | ½ (1 blank, 1 Extra Turn) | ⅕ (4 blank, 1 Extra Turn) |
| 6 | ⅔ (1 blank, 2 Extra Turn) | ¼ (3 blank, 1 Extra Turn) |
| 7 | ⅓ (2 blank, 1 Extra Turn) | ⅓ (2 blank, 1 Extra Turn) |
| 8 | ⅜ (5 blank, 3 Extra Turn) | ⅓ (2 blank, 1 Extra Turn) |
| 9 | ¾ (1 blank, 3 Extra Turn) | ⅕ (4 blank, 1 Extra Turn) |
| 10 | ½ (1 blank, 1 Extra Turn) | ½ (1 blank, 1 Extra Turn) |

*The probability for the second player is conditional on Player #1's having had a turn.

Next, a Chevalier-Level Game Card for Game 1a; 5 Players, is shown:

| Set | | | Max # | # Best- | # Always |
|---|---|---|---|---|---|
| Number | Gold Points | # Silver Rings | Turns | strategy | Take |
| 1 | 6 | 28 | 8 | 4 | 1 |
| 2 | 4 | 10 | 4 | 2 | 3 |
| 3 | 5 | 16 | 5 | 3 | 2 |
| 4 | 4.5 | 20 | 5 | 4 | 1 |
| 5 | 9 | 20 | 7 | 3 | 2 |
| 6 | 6.5 | 29 | 7 | 3 | 2 |
| 7 | 7 | 11 | 3 | 3 | 2 |
| 8 | 8 | 15 | 5 | 4 | 1 |
| 9 | 2.75 | 10 | 4 | 2 | 3 |
| 10 | 7.5 | 22 | 5 | 4 | 1 |

A card for Game 1a; 6 Players, can be prepared as follows:

| Set | Gold | # Silver | Max | | |
|---|---|---|---|---|---|
| Number | Points | Rings | # Turns | # Beststrategy | # AlwaysTake |
| 1 | 10 | 23 | 5 | 4 | 2 |
| 2 | 2 | 10 | 3 | 2 | 4 |
| 3 | 5 | 16 | 7 | 2 | 4 |
| 4 | 6 | 18 | 5 | 5 | 1 |
| 5 | 7 | 26 | 6 | 3 | 3 |
| 6 | 3 | 25 | 5 | 4 | 2 |
| 7 | 7 | 35 | 9 | 4 | 2 |
| 8 | 4 | 27 | 7 | 3 | 3 |
| 9 | 8 | 25 | 8 | 4 | 2 |
| 10 | 7 | 24 | 7 | 5 | 1 |

A Chevalier-Level Game Card for Game 1b; 3 Players:

| Set | Gold | | Max | | |
|---|---|---|---|---|---|
| Number | Points | # Silver Rings | # Turns | Prob BestStr | Prob AlTake |
| 1 | 8 | 3 | 4 | 3/4 | 1/4 |
| 2 | 6 | 10 | 7 | 1/2 | 1/2 |
| 3 | 5 | 11 | 5 | 2/3 | 1/3 |
| 4 | 7 | 7 | 33 | 2/3 | 1/3 |
| 5 | 5 | 16 | 5 | 3/4 | 1/4 |
| 6 | 3 | 12 | 6 | 2/3 | 1/3 |
| 7 | 2 | 8 | 3 | 1/4 | 3/4 |
| 8 | 5 | 4 | 3 | 2/3 | 1/3 |
| 9 | 6 | 9 | 5 | 3/4 | 1/4 |
| 10 | 9 | 5 | 3 | 1/2 | 1/2 |

A card for Game 1b; 4 Players:

| Set | Gold | | Max | | |
|---|---|---|---|---|---|
| Number | Points | # Silver Rings | # Turns | Prob Beststr | Prob AlTake |
| 1 | 3.73 | 12 | 4 | 3/4 | 1/4 |
| 2 | 3.5 | 20 | 7 | 2/3 | 1/3 |
| 3 | 4.5 | 21 | 9 | 1/2 | 1/2 |
| 4 | 7 | 13 | 8 | 2/3 | 1/3 |
| 5 | 5 | 16 | 5 | 3/4 | 1/4 |
| 6 | 6 | 19 | 6 | 1/4 | 3/4 |
| 7 | 3.75 | 14 | 5 | 1/2 | 1/2 |
| 8 | 5 | 12 | 6 | 2/3 | 1/3 |
| 9 | 4 | 18 | 6 | 1/2 | 1/2 |
| 10 | 6 | 20 | 7 | 3/4 | 1/4 |

A Chevalier-Level Game Card for use in Game 2a: Predetermined Number of Strategy Types, is now shown:

| Set | Gold | | Max | | |
|---|---|---|---|---|---|
| Number | Points | # Silver Rings | # Turns | # Beststrategy | # All Take |
| 1 | 8 | 30 | 6 | 5 | 1 |
| 2 | 10 | 36 | 10 | 3 | 3 |
| 3 | 3 | 25 | 5 | 2 | 4 |
| 4 | 7 | 22 | 6 | 4 | 2 |
| 5 | 12 | 18 | 5 | 4 | 2 |
| 6 | 6 | 19 | 6 | 3 | 3 |
| 7 | 9 | 20 | 5 | 5 | 1 |
| 8 | 3.5 | 21 | 7 | 2 | 4 |
| 9 | 5 | 23 | 8 | 5 | 1 |
| 10 | 3 | 13 | 4 | 3 | 3 |

A card for use in Game 2b: Binomial Assignment of Strategy Types, is now shown:

| Set | Gold | # | Max | | |
|---|---|---|---|---|---|
| Number | Points | Silver Rings | # Turns | Prob Beststr | Prob AlTake |
| 1 | 8 | 30 | 6 | 4/5 | 1/5 |
| 2 | 10 | 36 | 10 | 1/2 | 1/2 |
| 3 | 3 | 25 | 5 | 1/3 | 2/3 |
| 4 | 7 | 22 | 6 | 2/3 | 1/3 |
| 5 | 12 | 18 | 5 | 2/3 | 1/3 |
| 6 | 6 | 19 | 6 | 1/2 | 1/2 |
| 7 | 9 | 20 | 5 | 4/5 | 1/5 |
| 8 | 3.5 | 21 | 7 | 1/3 | 2/3 |
| 9 | 5 | 23 | 8 | 4/5 | 1/5 |
| 10 | 3 | 13 | 4 | 1/2 | 1/2 |

Next, a Chevalier-Level Game Card for use in Game 3: Position Exchange; 6 players, and Game 4: Bumping Process; 6 Players, is shown:

| | | # | Max | | | |
|---|---|---|---|---|---|---|
| Set | Gold | Silver | # | Cascade* | probability | Revolution |
| Number | Points | Rings | Turns | Position# | of Cascade | # Cascade |
| 1 | 8 | 12 | 3 | 2 | 3/4 | 2 |
| 2 | 4 | 14 | 6 | 4 | 3/5 | 2 |
| 3 | 5 | 20 | 7 | 4 | 1/2 | 3 |
| 4 | 7 | 7 | 3 | 3 | 2/3 | 2 |
| 5 | 6 | 28 | 5 | 6 | 1/2 | 4 |
| 6 | 10 | 14 | 6 | 4 | 3/5 | 2 |
| 7 | 7 | 21 | 5 | 5 | 2/3 | 3 |
| 8 | 3 | 19 | 4 | 3 | 1/4 | 3 |
| 9 | 10 | 14 | 6 | 4 | 1/3 | 2 |
| 10 | 6 | 12 | 3 | 2 | 1/2 | 2 |

*Note that a cascade can only occur if, after reallocation, the position is filled by a “Best Strategist.”

| SetNumber | Player 1 | Player 2 | Player 3 | Player 4 | Player 5 | Player 6 |
|---|---|---|---|---|---|---|
| 1 | All Take | All Take | Best Strat | Best Strat | All Take | Best Strat |
| 2 | All Take | Best Strat | All Take | Best Strat | Best Strat | Best Strat |
| 3 | Best Strat | All Take | Best Strat | Best Strat | Best Strat | All Take |
| 4 | Best Strat | All Take | Best Strat | Best Strat | All Take | Best Strat |
| 5 | All Take | All Take | Best Strat | Best Strat | All Take | All Take |
| 6 | All Take | Best Strat | All Take | Best Strat | Best Strat | Best Strat |
| 7 | Best Strat | All Take | All Take | All Take | Best Strat | Best Strat |
| 8 | Best Strat | All Take | Best Strat | Best Strat | All Take | Best Strat |
| 9 | All Take | Best Strat | All Take | Best Strat | Best Strat | Best Strat |
| 10 | Best Strat | All Take | Best Strat | Best Strat | All Take | Best Strat |

Insofar as certain terms used throughout this application have meanings specific to the Ring Game, and as a convenience, the following glossary of terms used throughout this application is provided.

Algorithm: a computational procedure, generally representable by a sequence of decision nodes and actions, that solves a particular problem. Here, the problem is to determine whether to “take” or “pass” an available silver ring.

Tall-take (a-t) equilibrium: starting from some particular playing position, rotation number and state of the game, the playing position and rotation number when the Ring becomes available, if players subsequently “take” silver rings at every opportunity.

Always Taker: a player who always “takes” an available ring. In Apprentice-Level and Squire-Level games, such players are Artificials. There are only Real Players in Chevalier-Level play, and these may sometimes be selected to play like Always Takers.

Apprentice: the introductory skill level for The Ring Game. After demonstrating proficiency in online play and tests, Apprentices are eligible for promotion to Squires.

Artificial Player: a constructed character whose moves are controlled by Real Players in table-top play and by The Ring Game Software in electronic play. In the former instance, Artificial Players can only be Always Takers, whose moves are effected by Real Players; electronic versions of The Ring Game have software that can simulate the moves of either unerring Best Strategists or Always Takers.

Balking Sequence: a planned series of “passes” intended to change the a-t equilibrium from its current location (playing position and rotation number) to the balker's playing position on the same or subsequent rotation number.

Base: a clockwise-rotating turntable which supports the carousel's Center Panel, horses and Ring Poles

Best Strategist: a player who is free to “take” or “pass” an available ring with a view to maximizing his/her (expected) point score. In table-top sessions of The Ring Game, Best Strategists are always Real Players. Electronic versions of The Ring Game have software which simulates unerring Best Strategists.

Binomial Distribution: a mathematical function which gives the likelihoods of having different numbers of Best Strategists and Always Takers in Chevalier-Level play. Each player has the same probability of being assigned the role of Best Strategist and, with complementary probability, being assigned the role of Always Taker.

Bumping: in Chevalier-Level Game 4, the procedure by which a player displaces another from his/her initial playing position.

Carousel: the backdrop for The Ring Game, the carousel has structural components (Base, Center Panel, horses, ring dispenser and Ring Poles) and ancillary items (Rings, Game cards, Random Event cards, Strategy/Identity cards)

Center Panel: a structural component of The Ring Game carousel, the Center Panel is a set of six hinged, decorative panels. Each panel has a pair of slots capable of displaying a Strategy/Identity card. In its folded conformation, the Center Panel fits into The Ring Game's box; opened up, the Center Panel fits into a hexagonal housing at the center of the carousel Base.

Chevalier: the most advanced skill level of The Ring Game.

Complete: a final rotation is said to be complete if the final-mover has the final turn.

Distance Function: the number of intervening playing positions between an origin location and a destination location, defined only in a “forwards” direction. The origin is a playing position on a particular rotation number, and the location a playing position on the same or subsequent rotation number. This concept is used in connection with Balking Sequences.

Envy: a penalty imposed on a Best Strategist if his/her opponent secures the gold ring in a variation of Squire-Level Game 2. The penalty is always less than one point, the value of a silver ring.

Expected Point Score: In Squire-Level and Chevalier-Level games, the summed products of probabilities and point scores from following a particular strategy.

Extra Turn: In Squire-Level Game 2, players may have one additional chance at the Ring Dispenser after the final-mover has had his/her turn on the final rotation, provided there are still rings remaining in the ring dispenser afterwards. Whether or not the Extra Turn materializes depends on the resolution of a random event.

Feasible: a term applied to Balking Sequences, when the number of available turns is no less than the associated Distance Function.

Final-Mover: the player in the last playing position.

Final Rotation: the rotation number which players designate as the one when the carousel ride ends. Players can decide that the final rotation is to be complete, in which case the final-mover has the last turn on the final rotation, or incomplete, in which case another player is chosen to have the final turn on the final rotation.

Final Turn: the last opportunity to access the ring dispenser, with no guarantee that there are rings remaining at the time.

First-Mover: the player in the first playing position.

Forced Pass: used in connection with the rule refinement introduced in Squire-Level Game 1. The rule refinement mandates that if three conditions are satisfied, a random event determines the move of the first in a “run” of Best Strategists. With a predetermined probability, such a player is required to take the available silver ring, and with the complementary probability, to pass it. The former outcome is called a forced take, the latter a forced pass.

Forced Take: The alternative move to a forced pass.

Game Card: Alternative sets of values for three parameters that are defined in every Ring Game session: (1) number of silver rings; (2) number of gold ring points; (3) maximum number of rotations (complete or incomplete). Table-top versions of The Ring Game have Game cards with ten sets of the three parameters for carousels with 2,3,4,5 and 6 players. These can be used in games at all skill levels, or players can establish their own values. Electronic versions of The Ring Game list only five sets of parameter values, but have software that, when prompted by players, generates additional parameter sets.

Gold Ring: the most valuable ring, which is available only after all silver rings have been taken.

Horse: the game piece for The Ring Game. Each player has one, situated in his/her playing position. Horses' forward orientation is determined by the counter-clockwise rotation of the carousel.

Identity: For a real player, the name of the character on his/her strategy/identity card. Real players get to choose their personae. In the table-top version there are six male and six female names, enough to fill the six playing positions on the carousel. Electronic versions have eight-position carousels, so for those sessions The Ring Game software lists eight male and eight female names.

Location: a vector, the first element of which is a playing position, and the second a rotation number. A location is (Null,Null) if: (1) the rotation is the final one and the playing position has an index greater than that of the player having the final turn; (2) the rotation number exceeds the final rotation.

Maximally Compact: a term applied to Balking Sequences, where the intended series of passes are consecutive. An equivalent definition is a Balking Sequence which would not be feasible if it were to begin on a subsequent rotation.

Move: the term for an action at the ring dispenser. Best Strategists can either take or pass an available ring, Always Takers necessarily take an available ring.

N: mnemonic for number of players, both Real and Artificial, in a particular game.

Name: the identity of the character on a strategy/identity card. Always Takers have no names, and the icon on their strategy/identity cards is a jester.

Null Location: a location which is inaccessible because of the restriction on the maximum number of rotations. This applies to playing positions after the one with the final turn on the final rotation, and to rotations beyond the maximum number.

p-c: the Real Player selected by a moderator to initiate position-exchange, before play begins in Chevalier-Level Game 3, and the Real Player selected by a moderator to begin the bumping process before play begins in Chevalier-Level Game 4.

Pass: one of the binary actions available to a Best Strategist. Passing a silver ring leaves the ring dispenser unchanged for the player having the next turn. It makes no sense to pass the gold ring.

Passing Cascade: consecutive passes by a run of Best Strategists. The rule refinement for Squire-Level Game 1 regulates the occurrence of passing cascades.

Performance Rating: supplied at the end of a game played on an electronic platform. For a Real Player, performance rating is his/her correct (unforced) moves as a percentage of all (unforced) moves.

Player: a participant in The Ring Game. Players may be either Real or Artificial, and either Best Strategists or Always Takers. In Apprentice-Level and Squire-Level games, real players are necessarily Best Strategists.

Playing position: the number on the Center Panel opposite a player's horse, those numbers indicating the order of “taking turns”. Because the carousel is circular, each playing position has a predecessor and a successor. Predecessors and successors are determined by modular arithmetic: the successor of the final-mover (situated in playing position #N) is the first-mover (situated in playing position #1); the predecessor of the first-mover is the final-mover.

Point Score: the point value of the rings on a player's Ring Pole at the end of a Ring Game. Each silver ring is worth one point; the point value of the gold ring is one of the parameters established during Set-Up.

Position-Exchange: single exchange of playing positions by the p-c in Chevalier-Level Game 3.

Predecessor: the playing position or player, having a turn just before the playing position or player in question. The predecessor to the first-mover is the final-mover; the predecessor to a player in playing position greater than 1 is the player in the playing position with the next smaller number.

probability: a primitive concept in Statistics, used here in its relative frequency sense.

Profitable: a term used in connection with Balking Sequences, meaning that the point value of the gold ring exceeds the point value of intentionally passed silver rings.

Random Event: an event which has more than one possible outcome. The relative frequency of occurrence of a particular outcome is given by its probability. When the outcome of a random event becomes known, the random event is said to be resolved. Every session of The Ring Game has a random event during Set-Up: the order of taking turns. Assigning playing positions by means of silver ring remaining cards resolves that particular random event.

Random Event cards: the set of Extra Turn and Blank cards that are used to resolve a particular random event: getting an additional turn or not in Squire-Level Game 2.

Real Player: a person playing The Ring Game.

Ring dispenser: a structural component of The Ring Game, which is shown in FIG. 2. The table-top apparatus has a spindle for creating a column of rings, the gold ring on the bottom, and two holders for silver rings remaining and rotations remaining cards. In electronic versions of The Ring Game, the ring dispenser is a gravity-drop arm that encases a row of silver rings, followed by the single gold ring.

Ring Pole: a structural component which is shown in FIG. 1. Each horse has its own Ring Pole, which is used to store the rings a player takes.

Rotation: a cycle of moves that begins with playing position #1. Rotations prior to the final rotation conclude with the move made by the player in playing position #N. If the final rotation is incomplete, it concludes with the player designated as final mover.

Rotations remaining card: an element of one of the “decks” in the ring dispenser. The rotations remaining card exposed in the ring dispenser shows the number of rotations which have not yet begun. The rotations remaining card tabled in front of the ring dispenser is subtracted from the parameter, maximum number of rotations, to determine the rotation number currently in progress.

Rule Refinement: a procedure introduced in Squire-Level Game 1 to regulate passing cascades. The procedure is invoked if three conditions are met, and prescribes the probabilities of a forced take and a forced pass for the first Best Strategist in a run.

Run: a succession of two or more Best Strategists in adjacent playing positions, i.e., the first Best Strategist in a run must have as their successor another Best Strategist.

Set-Up: the procedures prior to play during which players acquire strategy/identity cards, establish game parameters and determine the assignment of players to playing positions. That assignment determines the order of taking turns.

Silver ring: a ring that is worth one point in The Ring Game. The number of silver rings is one of the parameters determined during Set-Up.

Silver rings remaining card: an element of one of the “decks” in the ring dispenser, the other being the rotations remaining cards. The exposed silver rings remaining Card shows the current number of silver rings in the ring dispenser.

Spitefulness: behavior that is prohibited during the bumping phase of Chevalier-Level Game 4. A bump is said to be spiteful if the bumper chooses a playing position that lowers the expected point score of another at the cost of lowering his/her own expected point score.

Squire: the intermediate skill level in The Ring Game. After demonstrating proficiency in Apprentice-Level online play, and passing a series of online quizzes, a player may be promoted from Apprentice to Squire.

State of the Game: the set of conditions which determine whether a Best Strategist at the ring dispenser should take or pass the available silver ring. These condition include: the number of silver rings remaining, the point value for the gold ring; the current rotation number, the number of the final rotation, and the playing position of the final-mover.

Strategy: a planned sequence of takes and passes intended to maximize the (expected) point score of a Best Strategist, given opponents' expected strategies. Strategy is necessarily adaptive, responding to opponents' actual moves.

Strategy/Identity Card: the card which records whether or not a player is a Best Strategist and, if so, his/her name.

Successor: the playing position or player whose turn it is just after the playing position or player in question. The successor to the final-mover is the first-mover; the successor to any other playing position or player is the playing position or player with the next higher playing position number.

Sustainable: a term applied to Balking Sequences. A Best Strategist's Balking Sequence is said to be sustainable if the Best Strategist's successor is an Always Taker.

Take: one of the binary actions available to a Best Strategist. Taking a silver ring removes it from the ring dispenser, and adds one point to a player's point score.

Terminus: the playing position occupied by the last “Best Strategist” in a “run”, the one whose successor is an “Always Taker”.

Tournament Scribe: the name for the software routine that reports Real Players' Performance Ratings.

Electronic Versions of The Ring Game

Off-Line Play

Platforms like game player/TV monitor combinations and hand-held devices are in certain respects superior to the table-top version of The Ring Game. All games playable on the table-top version have their electronic counterparts. Software automatically updates the State of the Game, resolves random events and reliably invokes the Rule Refinement, dispensing with contrivances like silver rings remaining cards, rotations remaining cards and Random Event cards. In Chevalier-Level Games 3 and 4, there is no need for an impartial moderator to assign strategy types and p-c status.

Electronic platforms also add flexibility regarding the number and type of players, and incorporate feedback from performance ratings. Ring Game software permits carousels with more than six playing positions (the upper bound is 20), and supports Artificial Best Strategists who unerringly choose optimal strategies. At game's end the Tournament Scribe reports a Performance Rating for each Real Best Strategist, which is the number of that player's correct (unforced) moves as a percentage of all his/her (unforced) moves. There is also a legend of error messages to help players identity their mistakes. In Chevalier-Level Game 3, the Tournament Scribe also advises whether or not the p-c made the best possible position exchange, and, in Chevalier-Level Game 4, whether or not a Real Player's bump was the best one available.

The software for off-line play begins with a succession of screens that present essential aspects of The Ring Game and demonstrate Set-Up procedures that are common to all three skill levels. There follows a simulation of a 7-Player, Apprentice-Level game, and an option to play a pre-configured, two-Player game against a single, Artificial Best Strategist. At any point during that “tour”, a view can exit and “play for real”. Experienced players go directly to “play for real”, selecting the appropriate skill level. Squire-Level and Chevalier-Level games have separate instruction sets that explain the novel features of each.

The Ring Game Web Site

The Ring Game Web site can have an open area and one restricted to paid subscribers. The open area duplicates the introductory “tour” of the software for off-line play. Paid subscribers are entitled to unlimited online play, and can access the restricted area of The Ring Game Web site.

Online play incorporates all the features of off-line play, but The Ring Game Web site adds interactivity beyond the one-directional feedback of performance ratings. Subscribers can participate in Ring Game Chat rooms, passively observe online play, and take quizzes for promotion to a more advanced skill level. There is also a an e-mail address to which subscribers can submit questions, propose solutions and suggest new versions of The Ring Game.

Likewise, although the foregoing explanation of the preferred embodiment of this invention discusses the transfer of medical and educational information, this invention is not to be limited thereto. It is envisioned that the concepts taught herein could be applied to the transmission of any type of educational information over a computer network.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall there between. In particular, this invention should not be construed as being limited to the dimensions, proportions or arrangements disclosed herein.

What is claimed is:

1. A game apparatus for turnwise use by a plurality of players, each player having an associated game piece and an associated game score, comprising:
a turntable having a plurality of figures thereon;
a panel mounted on the turntable which indicates a plurality of playing positions and which accommodates at least one of a plurality of strategy/identity cards; and
a ring dispenser containing a plurality of rings, at least one of the rings having a first point value and at least one of the rings having a second point value, the ring dispenser having a portion from which one of said rings is presented as an available ring and is available to be taken;
wherein at each said player's turn that said player places their said game piece opposite to the ring dispenser, that said player making a decision whether to “take” or “pass” the ring that is available at the ring dispenser.

2. A game apparatus according to claim 1, wherein the player making the decision whether to “take” or “pass” the ring does so in order to maximize their game score.

3. A game apparatus according to claim 1, wherein at least one said player is a “Best Strategist”.

4. A game apparatus according to claim 3, wherein the player who is a “Best Strategist” every turn chooses an action consistent with maximizing that player's game score.

5. A game apparatus according to claim 1, wherein at least one said player is an “Always Taker”.

6. A game apparatus according to claim 5, wherein the player who is an “Always Taker” randomly, including probability zero, misses the representatively available ring.

7. A game apparatus according to claim 1, wherein a quantity of the first and the second rings is known.

8. A game apparatus according to claim 1, wherein at least one of the first point value and the second point value is known.

9. A game apparatus according to claim 1, wherein a maximum number of rotations of the turntable is specified, and one of said playing positions has a final move on a final rotation of the turntable.

10. A game apparatus according to claim 1, wherein an additional rotation of the turntable of a number which is at least 0 based upon a random event is effected.

11. A game apparatus according to claim 10, wherein the number of the additional rotations is an integer having a value of at least 1.

12. A method of turnwise game play by a plurality of players, each player having an associated game piece representation and an associated game score, comprising the steps of:
providing a turntable having a plurality of figures thereon;
providing a panel mounted on the turntable which indicates a plurality of playing positions and which accommodates a plurality of strategy/identity cards; and
providing a ring dispenser containing a plurality of rings, at least one of the rings having a first point value and at least one of the rings having a second point value, the ring dispenser having a portion from which one of said rings is presented and is available as an available ring to be taken;
placing, at each said player's turn, that said player's said game piece opposite to the ring dispenser; and
making, at that said player's turn, a decision whether to “take” or “pass” the available ring at the ring dispenser.

13. A method according to claim 12, wherein step of making the decision whether to “take” or “pass” the ring is effected by the player so as to maximize the player's game score.

14. A method according to claim 12, wherein at least one said player is software-generated.

15. A method according to claim 12, further comprising the step of:
generating, at a conclusion of game play, for at least one said player, a performance rating.

16. A method according to claim 12, further comprising the step of:
generating, at a conclusion of game play, for at least one said player, an error diagnostic.

17. A method according to claim 12, wherein at least one said player is a “Best Strategist”.

18. A method according to claim 17, wherein the player who is a “Best Strategist” every turn chooses an action consistent with maximizing that player's game score.

19. A method according to claim 12, wherein at least one said player is an “Always Taker”.

20. A method according to claim 19, wherein the player who is an “Always Taker” randomly, including probability zero, misses the representatively available ring.

21. A method according to claim 12, wherein a quantity of the first and the second rings is known.

22. A method according to claim 12, wherein at least one of the first point value and the second point value is known.

23. A method according to claim 12, wherein at least one of the first point value and the second point value and the number of rings is generated by an algorithm.

24. A method according to claim 12, wherein at least one of the first point value and the second point value and the number of rings generated by the algorithm varies.

25. A method according to claim 12, further comprising the step of:
specifying a maximum number of rotations of the turntable,
wherein one of said playing positions has a final move on a final rotation of the turntable.

26. A method according to claim 12, further comprising the step of:
effecting an additional rotation of the turntable of a number which is at least 0 based upon a random event.

27. A method according to claim 26, wherein the number of the additional rotations is an integer having a value of at least 1.

28. A method of turnwise game play by a plurality of players, each said player having an associated game piece representation and an associated game score, comprising the steps of:
providing a representation of a turntable having a plurality of figures thereon;
providing a representation of a plurality of playing positions;
providing a plurality of strategy/identity card representations; and
providing a representation of a ring dispenser having a quantity of a plurality of represented rings, at least one of the represented rings in the represented ring dispenser representation having a first point value and at least one of the represented rings in the represented ring dispenser representation having a second point value, the represented ring dispenser having a portion from which one of said represented rings is fed and is representatively available as an available ring to be taken;
placing, at each said player's turn, that said player's said game piece representation opposite to the represented ring dispenser; and
making, at that said player's turn, a decision whether to “take” or “pass” the representatively available ring at the represented ring dispenser.

29. A method according to claim 28, wherein step of making the decision whether to “take” or “pass” the represented available ring is effected by the player so as to maximize the player's game score.

30. A method according to claim 28, wherein at least one said player is software-generated.

31. A method according to claim 28, further comprising the step of:
generating, at a conclusion of game play, for at least one said player, a performance rating.

32. A method according to claim 28, further comprising the step of:
generating, at a conclusion of game play, for at least one said player, an error diagnostic.

33. A method according to claim 28, wherein at least one said player is a “Best Strategist”.

34. A method according to claim 33, wherein the player who is a “Best Strategist” every turn chooses an action consistent with maximizing that player's game score.

35. A method according to claim 28, wherein at least one said player is an “Always Taker”.

36. A method according to claim 35, wherein the player who is an “Always Taker” randomly, including probability zero, misses the representatively available ring.

37. A method according to claim 28, wherein a quantity of the first and the second rings is known.

38. A method according to claim 28, wherein at least one of the first point value and the second point value is known.

39. A method according to claim 28, wherein at least one of the first point value and the second point value and the number of rings is generated by an algorithm.

40. A method according to claim 39, wherein at least one of the first point value and the second point value and the number of rings generated by the algorithm varies.

41. A method according to claim 28, further comprising the step of:
specifying a maximum number of rotations of the turntable, wherein one of said playing positions has a final move on a final rotation of the turntable.

42. A method according to claim 28, further comprising the step of:
effecting an additional rotation of the turntable of a number which is at least 0 based upon a random event.

43. A method according to claim 42, wherein the number of the additional rotations is an integer having a value of at least 1.

44. A computer-readable storage medium containing a computer program for performing the method of claim 28.

45. A method according to claim 44, wherein step of making the decision whether to “take” or “pass” the represented available ring is effected by the player so as to maximize the player's game score.

46. A method according to claim 44, wherein at least one said player is software-generated.

47. A method according to claim 44, further comprising the step of:
generating, at a conclusion of game play, for at least one said player, a performance rating.

48. A method according to claim 44, further comprising the step of:
generating, at a conclusion of game play, for at least one said player, an error diagnostic.

49. A method according to claim 44, wherein at least one said player is a “Best Strategist”.

50. A method according to claim 49, wherein the player who is a “Best Strategist” every turn chooses an action consistent with maximizing that player's game score.

51. A method according to claim 44, wherein at least one said player is an “Always Taker”.

52. A method according to claim 51, wherein the player who is an “Always Taker” randomly, including probability zero, misses the representatively available ring.

53. A method according to claim 44, wherein a quantity of the first and the second rings is known.

54. A method according to claim 44, wherein at least one of the first point value and the second point value is known.

55. A method according to claim 44, wherein at least one of the first point value and the second point value and the number of rings is generated by an algorithm.

56. A method according to claim 55, wherein at least one of the first point value and the second point value and the number of rings generated by the algorithm varies.

57. A method according to claim 44, further comprising the step of:
specifying a maximum number of rotations of the turntable,
wherein one of said playing positions has a final move on a final rotation of the turntable.

58. A method according to claim 44, further comprising the step of:
effecting an additional rotation of the turntable of a number which is at least 0 based upon a random event.

59. A method according to claim 58, wherein the number of the additional rotations is an integer having a value of at least 1.

60. A portable electronic device, comprising:
an input section for receiving input information;
an output section for outputting information;
a storage medium containing a computer program for performing the method of claim 28; and
a processor for processing input information and providing the output information using the computer program.

61. A method according to claim 60, wherein step of making the decision whether to “take” or “pass” the represented available ring is effected by the player so as to maximize the player's game score.

62. A method according to claim 60, wherein at least one said player is software-generated.

63. A method according to claim 60, further comprising the step of:
generating, at a conclusion of game play, for at least one said player, a performance rating.

64. A method according to claim 60, further comprising the step of:
generating, at a conclusion of game play, for at least one said player, an error diagnostic.

65. A method according to claim 60, wherein at least one said player is a “Best Strategist”.

66. A method according to claim 65, wherein the player who is a “Best Strategist” every turn chooses an action consistent with maximizing that player's game score.

67. A method according to claim 60, wherein at least one said player is an “Always Taker”.

68. A method according to claim 67, wherein the player who is an “Always Taker” randomly, including probability zero, misses the representatively available ring.

69. A method according to claim 60, wherein a quantity of the first and the second rings is known.

70. A method according to claim 60, wherein at least one of the first point value and the second point value is known.

71. A method according to claim 60, wherein at least one of the first point value and the second point value and the number of rings is generated by an algorithm.

72. A method according to claim 71, wherein at least one of the first point value and the second point value and the number of rings generated by the algorithm varies.

73. A method according to claim 60, further comprising the step of:
specifying a maximum number of rotations of the turntable,
wherein one of said playing positions has a final move on a final rotation of the turntable.

74. A method according to claim 60, further comprising the step of:
effecting an additional rotation of the turntable of a number which is at least 0 based upon a random event.

75. A method according to claim 74, wherein the number of the additional rotations is an integer having a value of at least 1.
